(19) United States
(12) Patent Application Publication
(10) Pub. No.: US 2025/0128905 A1
(43) Pub. Date: Apr. 24, 2025

(54) SHEET PROCESSING APPARATUS AND IMAGE FORMING APPARATUS

(71) Applicants: Yuusuke SHIBASAKI, Kanagawa (JP); Atsushi SHINODA, Kanagawa (JP); Shuuto TOHKAISHI, Kanagawa (JP); Sho ASANO, Kanagawa (JP); Wataru TAKAHASHI, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Suzuka FUJITA, Kanagawa (JP); Naofumi YOSHIDA, Kanagawa (JP); Ryota TAKAYAMA, Kanagawa (JP); Hirotaka YASUKAWA, Kanagawa (JP); Yoshito SUZUKI, Kanagawa (JP); Shinya MONMA, Kanagawa (JP); Yuji SUZUKI, Kanagawa (JP); Wataru NOZAKI, Kanagawa (JP); Jun YAMADA, Kanagawa (JP); Naohiro YOSHIDA, Kanagawa (JP); Yusuke HIRONO, Kanagawa (JP); Takahiro WATANABE, Kanagawa (JP); Yohsuke HARAGUCHI, Kanagawa (JP)

(72) Inventors: Yuusuke SHIBASAKI, Kanagawa (JP); Atsushi SHINODA, Kanagawa (JP); Shuuto TOHKAISHI, Kanagawa (JP); Sho ASANO, Kanagawa (JP); Wataru TAKAHASHI, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Suzuka FUJITA, Kanagawa (JP); Naofumi YOSHIDA, Kanagawa (JP); Ryota TAKAYAMA, Kanagawa (JP); Hirotaka YASUKAWA, Kanagawa (JP); Yoshito SUZUKI, Kanagawa (JP); Shinya MONMA, Kanagawa (JP); Yuji SUZUKI, Kanagawa (JP); Wataru NOZAKI, Kanagawa (JP); Jun YAMADA, Kanagawa (JP); Naohiro YOSHIDA, Kanagawa (JP); Yusuke HIRONO, Kanagawa (JP); Takahiro WATANABE, Kanagawa (JP); Yohsuke HARAGUCHI, Kanagawa (JP)

(73) Assignee: Ricoh Company, Ltd., Tokyo (JP)

(21) Appl. No.: 18/904,327

(22) Filed: Oct. 2, 2024

(30) Foreign Application Priority Data
Oct. 24, 2023 (JP) 2023-182566

(51) Int. Cl. B65H 45/16; B41J 11/00; B42C 13/00; B65H 37/04; G03G 15/00

(52) U.S. Cl. CPC B65H 45/16; B41J 11/0015; B42C 13/00; B65H 37/04; G03G 15/6541; G03G 15/6582; B65H 2301/4521; B65H 2403/40; B65H 2801/06; B65H 2801/15; B65H 2801/27; G03G 2215/00877

(57) ABSTRACT

A sheet processing apparatus includes a conveyor, a first folding roller, a second folding roller, a return conveyance passage, and a third folding roller. The conveyor conveys a sheet along a main conveyance passage in a conveyance direction. The second folding roller facing the first folding roller across the main conveyance passage conveys the sheet by a first conveyance amount. The return conveyance passage having a curvature is branched from the main conveyance passage at a branching position and is merged to the main conveyance passage at a merging position. The third folding roller facing the second folding roller across the return conveyance passage conveys the sheet by a second conveyance amount smaller than the first conveyance amount of the second folding roller. The second folding roller is on an outer peripheral side and the third folding roller is on an inner peripheral side of the return conveyance passage.

### CROSS-REFERENCE TO RELATED APPLICATION

This patent application is based on and claims priority pursuant to 35 U.S.C. § 119 (a) to Japanese Patent Application No. 2023-182566, filed on Oct. 24, 2023, in the Japan Patent Office, the entire disclosure of which is hereby incorporated by reference herein.

### BACKGROUND

### Technical Field

Embodiments of the present disclosure relates to a sheet processing apparatus, and an image forming apparatus.

### Related Art

There is known a sheet processing apparatus that performs a predetermined process on a sheet on which an image is formed by an image forming apparatus that forms an image on a sheet-shaped medium (hereinafter referred to as a “sheet”). There is a conventionally known sheet processing apparatus that performs a “folding process” of folding a sheet on which an image is formed into a predetermined shape (for example, Z-fold, outer tri-fold, and half-fold) is known.

A sheet processing apparatus that can be attached inside an image forming apparatus is also known. In order to improve accuracy of a folding position in an in-body type sheet processing apparatus, a configuration is disclosed in which a folding motor is controlled by feedback control using an integral gain, and a sheet is allowed to pass through a loop conveyance passage to enable a half-fold process.

As in the in-body type sheet processing apparatus disclosed in the sheet processing apparatus in the art, when a sheet after a fold is formed is conveyed using a loop conveyance passage having a curvature, a position of the fold deviates from a nip of a conveyance roller pair. When the sheet enters and passes through the nip in a state in which the fold deviates from the nip, for example, an improper fold might be formed at a position different from that of a proper fold in a case where the sheet is half-folded.

In other words, when a sheet on which a fold is formed is conveyed by a loop conveyance passage having a curvature, a phenomenon occurs in which a conveyance distance (conveyance passage length) varies depending on a portion of the sheet even if this is a single sheet, as if relative lengths (sheet lengths) in a conveyance direction are different between the portions. In other words, in a case where a fold is formed on one sheet, when the fold is grasped as a boundary, the sheet is divided into a portion (piece) to be conveyed along a passage corresponding to an inner peripheral side of the loop conveyance passage and a portion (piece) to be conveyed along a passage corresponding to an outer peripheral side of the loop conveyance passage.

In this case, since the conveyance distance of the piece on the inner peripheral side of the sheet (the sheet conveyed with the fold as the head) having passed through the loop conveyance passage is relatively shorter than that of the piece on the outer peripheral side, the sheet length is longer, and not the fold but a portion in the vicinity of the fold in which the piece on the inner peripheral side deviates downstream in the conveyance direction than the piece on the outer peripheral side is the head in the conveyance direction. As described above, when passing through the nip of the conveyance roller pair in a state in which the head is a portion deviating from the fold, an improper fold is formed in a portion different from the portion of the proper fold.

In the sheet processing apparatus that performs the folding process using the loop conveyance passage, there is a problem that the fold deviates from the nip position of the conveyance roller pair used for conveyance, so that the improper fold is formed, and so-called “box-fold” occurs.

### SUMMARY

Embodiments of the present disclosure described herein provide a novel sheet processing apparatus includes a conveyor, a first folding roller, a second folding roller, a return conveyance passage, and a third folding roller. The conveyor conveys a sheet along a main conveyance passage in a conveyance direction. The second folding roller that is disposed facing the first folding roller across the main conveyance passage conveys the sheet by a first conveyance amount. The return conveyance passage that has a curvature is branched from the main conveyance passage at a branching position upstream from the first folding roller in the conveyance direction and is merged to the main conveyance passage at a merging position upstream from the branching position in the conveyance direction. The third folding roller that is disposed facing the second folding roller across the return conveyance passage conveys the sheet by a second conveyance amount smaller than the first conveyance amount of the second folding roller. The second folding roller is disposed on an outer peripheral side of the return conveyance passage, and the third folding roller is disposed on an inner peripheral side of the return conveyance passage.

Further, embodiments of the present disclosure described herein provide an image forming apparatus including a housing, an image forming device included in the housing to form an image on a sheet, and the above-described sheet processing apparatus that is detachably attached to the housing and performs a given process on the sheet on which an image is formed by the image forming device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external view illustrating an example of a multifunction peripheral (MFP) as an embodiment of an image forming apparatus according to an embodiment of the present disclosure;

FIG. 2 is an external view of another example of the MFP as the embodiment of the image forming apparatus according to an embodiment of the present disclosure;

FIG. 3 is a functional block diagram corresponding to the example of the MFP according to the present embodiment;

FIG. 4A is a functional block diagram corresponding to another example of the MFP according to the present embodiment;

FIG. 4B is a diagram illustrating a schematic configuration of the MFP of FIG. 4A;

FIG. 5 is a diagram illustrating a configuration example of an embodiment of a sheet processing apparatus according to an embodiment of the present disclosure;

FIG. 6 is a hardware configuration diagram of the embodiment;

FIG. 7 is a diagram for illustrating one step of a shift discharge mode by a binding processing device according to the present embodiment;

FIGS. 8A and 8B are diagrams for illustrating one step of the shift discharge mode by the binding processing device according to the present embodiment;

FIG. 9 is a diagram for illustrating one step of the shift discharge mode by the binding processing device according to the present embodiment;

FIG. 10 is a diagram for illustrating one step of the shift discharge mode by the binding processing device according to the present embodiment;

FIG. 11 is a diagram for illustrating one step of a binding discharge mode by the binding processing device according to the present embodiment;

FIG. 12 is a diagram for illustrating one step of the binding discharge mode by the binding processing device according to the present embodiment;

FIG. 13 is a diagram for illustrating one step of the binding discharge mode by the binding processing device according to the present embodiment;

FIGS. 14A and 14B are diagrams for illustrating one step of the binding discharge mode by the binding processing device according to the present embodiment;

FIG. 15 is a diagram for illustrating one step of the binding discharge mode by the binding processing device according to the present embodiment;

FIG. 16 is a diagram for illustrating one step of the binding discharge mode by the binding processing device according to the present embodiment;

FIG. 17 is a diagram illustrating another configuration example of a folding processing unit according to the present embodiment;

FIG. 18 is a diagram for illustrating one step of Z-fold by the binding processing device according to the present embodiment;

FIG. 19 is a diagram for illustrating one step of Z-fold by the binding processing device according to the present embodiment;

FIG. 20 is a diagram for illustrating one step of Z-fold by the binding processing device according to the present embodiment;

FIG. 21 is a diagram for illustrating one step of Z-fold by the binding processing device according to the present embodiment;

FIG. 22 is a diagram for illustrating one step of Z-fold by the binding processing device according to the present embodiment;

FIG. 23 is a diagram for illustrating one step of Z-fold by the binding processing device according to the present embodiment;

FIG. 24 is a diagram for illustrating one step of Z-fold by the binding processing device according to the present embodiment;

FIG. 25 is a diagram for illustrating one step of half-fold by the binding processing device according to the present embodiment;

FIG. 26 is a diagram for illustrating one step of half-fold by the binding processing device according to the present embodiment;

FIG. 27 is a diagram for illustrating one step of half-fold by the binding processing device according to the present embodiment;

FIG. 28 is a diagram for illustrating one step of half-fold by the binding processing device according to the present embodiment;

FIG. 29 is a diagram for illustrating one step of half-fold by the binding processing device according to the present embodiment;

FIG. 30 is a diagram for illustrating one step of half-fold by the binding processing device according to the present embodiment;

FIG. 31 is a diagram for illustrating one step of half-fold by the binding processing device according to the present embodiment;

FIG. 32 is a diagram for illustrating one step of half-fold by the binding processing device according to the present embodiment;

FIG. 33 is a diagram for illustrating a problem of a conventional binding processing device;

FIG. 34 is a diagram for illustrating a problem of a conventional binding processing device;

FIG. 35 is a diagram for illustrating a problem of a conventional binding processing device;

FIG. 36 is a diagram for illustrating a box-fold occurring in the conventional binding processing device;

FIG. 37 is a diagram for illustrating a cause of the box-fold;

FIG. 38 is a diagram for illustrating a cause of the box-fold;

FIG. 39 is a diagram for illustrating a first embodiment of a sheet processing apparatus according to an embodiment of the present disclosure;

FIG. 40 is a diagram for illustrating the first embodiment of the sheet processing apparatus according to an embodiment of the present disclosure;

FIG. 41 is a diagram for illustrating the first embodiment of the sheet processing apparatus according to an embodiment of the present disclosure;

FIG. 42 is a diagram for illustrating an effect of the first embodiment according to an embodiment of the present disclosure;

FIG. 43 is a diagram for illustrating a second embodiment of a sheet processing apparatus according to an embodiment of the present disclosure;

FIG. 44 is a diagram for illustrating a third embodiment of a sheet processing apparatus according to an embodiment of the present disclosure;

FIG. 45 is a diagram for illustrating a fourth embodiment of a sheet processing apparatus according to an embodiment of the present disclosure;

FIGS. 46A and 46B are diagrams for illustrating a configuration example of the fourth embodiment of the sheet processing apparatus according to an embodiment of the present disclosure;

FIGS. 47A and 47B are diagrams for illustrating a configuration example of the fourth embodiment of the sheet processing apparatus according to an embodiment of the present disclosure;

FIG. 48 is a diagram for illustrating a fifth embodiment of a sheet processing apparatus according to an embodiment of the present disclosure; and

FIG. 49 is a diagram for illustrating a sixth embodiment of a sheet processing apparatus according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Embodiment of Image Forming Apparatus

An MFP 1 as an embodiment of an image forming apparatus according to the present disclosure will be described with reference to the drawings.

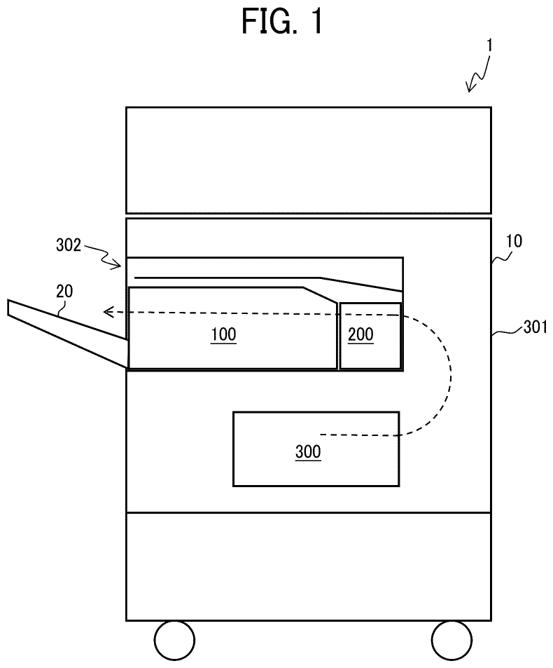

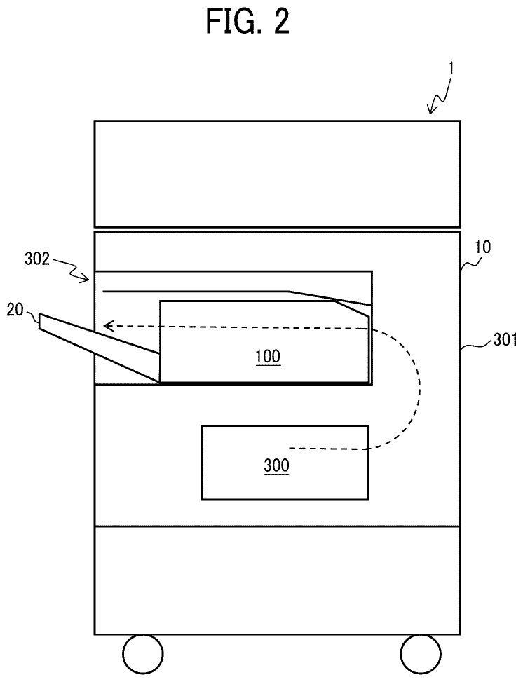

FIGS. 1 and 2 are external views of the MFP 1 according to the present embodiment.

The MFP 1 is an apparatus having an image forming function of forming an image on a sheet S as a sheet-shaped medium and a post-processing function of performing a predetermined sheet process (post-process) on the sheet S on which the image is recorded. As a specific example of the sheet S, “paper” generally used in image formation (copying and printing) is assumed.

As illustrated in FIG. 1, the MFP 1 includes an image forming apparatus 10, and the image forming apparatus 10 mainly includes a housing 301 and an image forming device 300 inside the housing 301. The housing 301 is a box-shaped member in which an internal space for accommodating components of the MFP 1 is formed. An in-body space 302 accessible from the outside of the MFP 1 is formed in the housing 301. The in-body space 302 is a portion exposed to the outside obtained by cutting out an outer side wall of the housing 301, and is formed, for example, slightly above the center in a vertical direction of the housing 301.

As an optional unit for adding an optional function, a folding processing unit 200 that enables a folding process and a binding processing unit 100 that enables a binding process of binding a plurality of sheets S in a bundle can be attached to the in-body space 302. The folding processing unit 200 corresponds to an embodiment of the sheet processing apparatus according to the present disclosure.

The image forming device 300 discharges the sheet S picked up and conveyed from a sheet stacking tray to the folding processing unit 200 and the binding processing unit 100. The image forming device 300 may be an inkjet system that forms an image using ink or an electrophotographic system that forms an image using toner. Since the image forming device 300 has an already known configuration, a detailed description thereof is omitted.

The folding processing unit 200 is attached to the in-body space 302 of the MFP 1 on a downstream side of the image forming device 300 and on an upstream side of the binding processing unit 100 in a conveyance passage of the sheet S from the image forming device 300 to the binding processing unit 100 (passage indicated by dashed arrow in FIG. 1). In other words, in the example of the MFP 1, the sheet S on which an image is formed by the image forming device 300 is first delivered to the folding processing unit 200 and is subjected to a predetermined folding process, and then delivered to the binding processing unit 100 and is subjected to a binding process to be described later.

The folding processing unit 200 is detachably attached to the MFP 1. When the folding processing unit 200 is detached, a state illustrated in FIG. 2 is obtained. In this case, the sheet S on which the image is formed by the image forming device 300 is directly delivered to the binding processing unit 100 and then is subjected to the binding process. Another processing unit that performs an optional process on the sheet S may be attached to the position where the folding processing unit 200 is detached in the in-body space 302.

Control Configuration of Medium Processing Apparatus Including Image Forming Apparatus

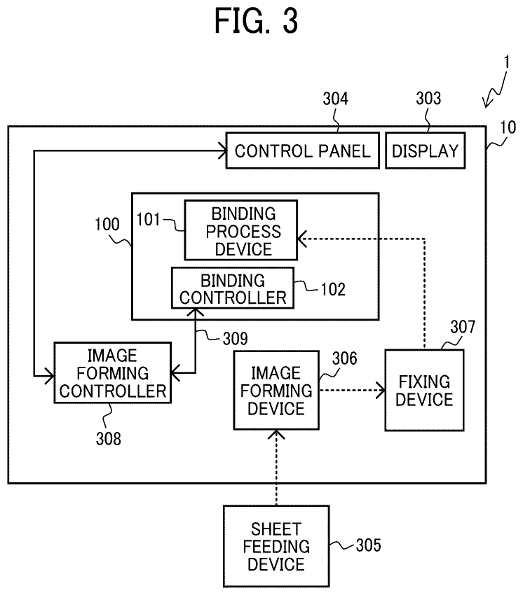

A description is given of a control configuration of the MFP 1 including the binding processing unit 100, with reference to FIG. 3.

FIG. 3 is a diagram illustrating the control configuration of the MFP 1 in the state in which the folding processing unit 200 is detached (refer to FIG. 2).

In FIG. 3, the conveyance passage of the sheet S (flow of the sheet S) is indicated by a broken line arrow, and a path of a communication signal (control signal) (flow of a signal) is indicated by a solid line arrow.

The MFP 1 includes a display 303 that notifies a user of a state and operation contents of various devices, a control panel 304 with which a user operates to set a mode or the number of copies, and a sheet feeder 305 that stores the sheets S and feeds the sheets S sheet by sheet. The MFP 1 includes an image forming unit 306 that forms a latent image on a photoconductor omitted in FIG. 3, and transfers the image to the sheet S, and a fixing unit 307 that fixes the image transferred to the sheet S. The MFP 1 further includes an image forming controller 308 that controls an operation of each unit described above.

The binding processing unit 100 as an embodiment of the medium processing apparatus receives an instruction for processing from the image forming controller 308 of the MFP 1 to the binding controller 102 through a communication line 309, and performs specified processing on the sheet S specified by the binding process device 101.

The image forming controller 308 and binding controller 102 that are connected are connected through the communication line 309 and can exchange information. Thus, information regarding an operation mode, information of a size of the sheet S and timing are exchanged, enabling a systematic operation.

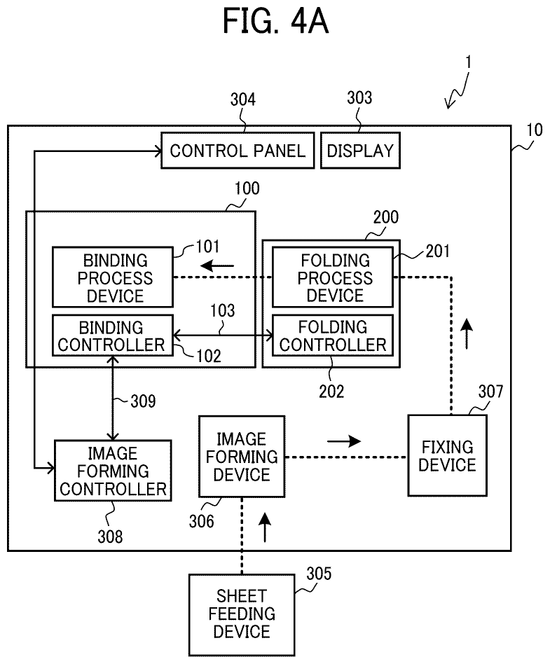

FIG. 4A is a functional block diagram corresponding to another example of the MFP 1 according to the present embodiment.

FIG. 4B is a diagram illustrating the control configuration of the MFP 1 to which the folding processing unit 200 is attached (refer to FIG. 1).

In FIGS. 4A and 4B, the conveyance passage of the sheet S (flow of the sheet S) is indicated by a broken line arrow, and a path of a communication signal (control signal) (flow of a signal) is indicated by a solid line arrow.

The MFP 1 similarly includes the display 303, the control panel 304, and the sheet feeder 305. The image forming unit 306 and the image forming controller 308 are similarly included.

The binding processing unit 100 as an embodiment of the medium processing apparatus receives an instruction for processing from the image forming controller 308 of the MFP 1 to the binding controller 102 through a communication line 309, and performs specified processing on the sheet S specified by the binding process device 101. The binding process device 101 is notified of specification information of processing contents for the sheet S via the folding processor 201.

The image forming controller 308 and binding controller 102 that are connected are connected through the communication line 309 and can exchange information. Thus, information regarding an operation mode, information of a size of the sheet S and timing are exchanged, enabling a systematic operation.

An instruction for processing is issued from the image forming controller 308 of the MFP 1 to the binding controller 102 through the communication line 309, and an instruction is issued from the binding controller 102 to a folding controller 202 through the communication line 103 in the folding processing unit 200. The folding controller 202 controls the folding processor 201 to perform the indicated folding process.

### Internal Configurations of Folding Processing Unit and Binding Processing Unit

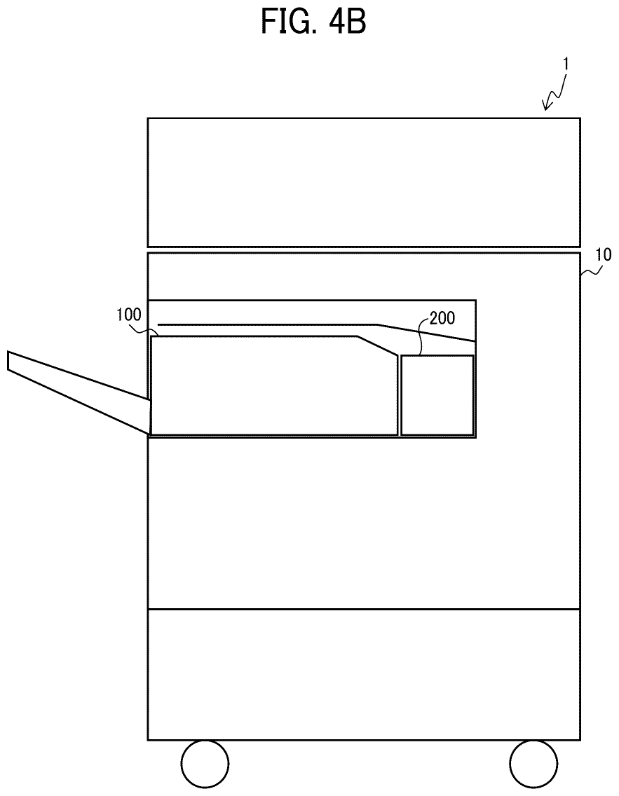

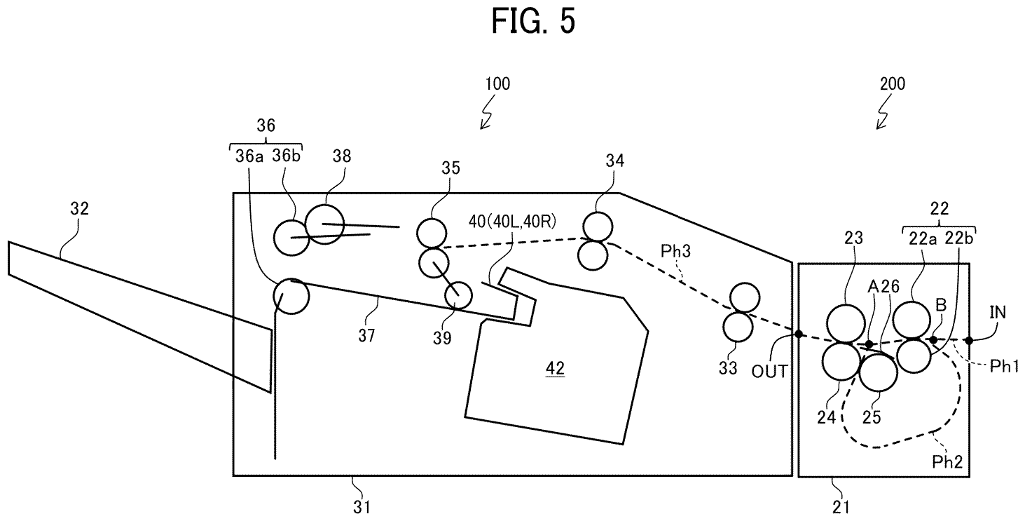

FIG. 5 is a diagram illustrating an internal configuration of the folding processing unit 200 and the binding processing unit 100. Each of the folding processing unit 200 and the binding processing unit 100 is made a unit, and an input-output interface of the sheet S can be connected to each other. In other words, an input interface IN of the folding processing unit 200 is connectable to an output interface of the image forming device 300. An input interface of the binding processing unit 100 is connectable to an output interface of the image forming device 300 and an output interface OUT of the folding processing unit 200.

### Internal Configuration of Folding Processing Unit

The folding processing unit 200 performs the folding process that folds the sheet S on which the image is formed by the image forming device 300 into a predetermined shape (for example, Z-fold, outer tri-fold, or half-fold). As illustrated in FIG. 5, the folding processing unit 200 includes a folding unit housing 21, a conveyance roller pair 22 forming a conveyor, a first folding roller 23, a second folding roller 24, a third folding roller 25, and a guide plate 26 as a guide member.

The folding unit housing 21 has a box shape in which an internal space for accommodating components of the folding processing unit 200 is formed. A main conveyance passage Ph1 and a return conveyance passage Ph2, which are spaces through which the sheet S passes, are formed in the internal space of the folding unit housing 21. The main conveyance passage Ph1 is a conveyance passage from an input interface IN connected to the image forming device 300 to an output interface OUT connected to the binding processing unit 100. Hereinafter, a direction from the input interface IN to the output interface OUT on the main conveyance passage Ph1 is referred to as a “conveyance direction”.

The return conveyance passage Ph2 is a loop-shaped conveyance passage that branches from the main conveyance passage Ph1 at a branch position A and joins the main conveyance passage Ph1 at a joining position B. The joining position B is located on an upstream side of the branch position A in the conveyance direction and on an upstream side of the conveyance roller pair 22. The return conveyance passage Ph2 corresponds to a curvature conveyance passage having a curvature that conveys the sheet S from the branch position A toward the joining position B. The return conveyance passage Ph2 has a gap (conveyance passage gap “g”) through which the sheet S can pass. A wall surface that forms the gap is formed of a wall surface on an inner peripheral side and a wall surface on an outer peripheral side of the curvature. In the following description, they are sometimes appropriately referred to as an “inner peripheral side wall surface” and an “outer peripheral side wall surface”.

The conveyance roller pair 22 conveys the sheet S along the main conveyance passage Ph1 in the conveyance direction. The conveyance roller pair 22 includes a driving roller 22a and a driven roller 22b disposed to face each other across the main conveyance passage Ph1 on the upstream side of the branch position A in the conveyance direction and on a downstream side of the joining position B in the conveyance direction (in other words, between the branch position A and the joining position B).

The driving roller 22a and the driven roller 22b are rotatably supported by the folding unit housing 21. The driving roller 22a to which a driving force of a conveyance motor is transmitted rotates forward in a direction of conveying the sheet S in the conveyance direction (clockwise direction in FIG. 5). The driven roller 22b is disposed to face the driving roller 22a via the main conveyance passage Ph1 and driven by the rotation of the driving roller 22a. When the conveyance motor is driven in a state in which the sheet S enters (is interposed in) a nip formed by the driving roller 22a and the driven roller 22b, the sheet S is conveyed in the conveyance direction along the main conveyance passage Ph1.

The first folding roller 23 is rotatably supported by the folding unit housing 21 at a position facing the main conveyance passage Ph1.

The second folding roller 24 is rotatably supported in the folding unit housing 21 at a position facing both the main conveyance passage Ph1 and the return conveyance passage Ph2 and forming a nip paired with the first folding roller 23.

The third folding roller 25 is rotatably supported in the folding unit housing 21 at a position facing the return conveyance passage Ph2 and forming a nip paired with the second folding roller 24.

In other words, the first folding roller 23 and the second folding roller 24 are disposed to face each other across the main conveyance passage Ph1 on a downstream side of the branch position A in the conveyance direction. The second folding roller 24 and the third folding roller 25 are disposed between the branch position A and the joining position B to face each other across the return conveyance passage Ph2.

The first folding roller 23 includes a first driving force transmission mechanism to which a driving force from a drive source that drives the second folding roller 24 is transmitted. The first folding roller 23 receives the driving force supplied from the drive source of the second folding roller 24 via the first driving force transmission mechanism, and rotates forward and reversely. The forward rotation of the first folding roller 23 conveys the sheet S on the main conveyance passage Ph1 in the conveyance direction. The reverse rotation of the first folding roller 23 is rotation in a direction opposite to the forward rotation.

The second folding roller 24 includes a second driving force transmission mechanism to which the driving force from the drive source is transmitted. The second folding roller 24 rotates forward and reversely by the driving force received from the second driving force transmission mechanism. The forward rotation of the second folding roller 24 conveys the sheet S on the main conveyance passage Ph1 in the conveyance direction and conveys the sheet S on the return conveyance passage Ph2 from the joining position B to the branch position A. The reverse rotation of the second folding roller 24 is rotation in a direction opposite to the forward rotation.

The drive source of the second folding roller 24 enables normal rotation of rotating the first folding roller 23 and the third folding roller 25 forward and reverse rotation of rotating the second folding roller 24 reversely via the first driving force transmission mechanism coupled to the second driving force transmission mechanism and a third driving force transmission mechanism.

The third folding roller 25 includes the third driving force transmission mechanism to which the driving force is transmitted from the drive source that drives the second folding roller 24. The third folding roller 25 receives the driving force supplied from the drive source of the second folding motor via the third driving force transmission mechanism, and rotates forward and reversely. The forward rotation of the third folding roller 25 conveys the sheet S on the return conveyance passage Ph2 from the joining position B to the branch position A. The reverse rotation of the third folding roller 25 is rotation in a direction opposite to the forward rotation.

The guide plate 26 is rotatably supported in the folding unit housing 21 in the vicinity of the branch position A. The guide plate 26 switches between two postures of a “first posture” when the sheet S is conveyed downstream from the joining position B through the branch position A, and a “second posture” when the sheet S conveyed from the joining position B is conveyed from the branch position A toward the return conveyance passage Ph2. The guide plate 26 is disposed in a rotatable state so as to be in either the first posture or the second posture.

The first posture is a posture of the guide plate 26 that allows the sheet S to be conveyed on the conveyance direction on the main conveyance passage Ph1 and prevents the sheet S conveyed in the conveyance direction on the main conveyance passage Ph1 from entering the return conveyance passage Ph2 through the branch position A. The guide plate 26 in the first posture allows the sheet S on the return conveyance passage Ph2 to enter the main conveyance passage Ph1 through the branch position A.

The second posture is the posture of the guide plate 26 that allows the sheet S to be conveyed from one of the main conveyance passage Ph1 and the return conveyance passage Ph2 to the other through the branch position A.

The binding processing unit 100 performs the binding process (post-process) of binding in a bundle a plurality of sheets S (hereinafter, referred to as a “sheet bundle Sb”) on which an image is formed by the image forming device 300. A bundle of a plurality of sheets S is hereinafter referred to as the “sheet bundle Sb”.

### Internal Configuration of Binding Processing Unit

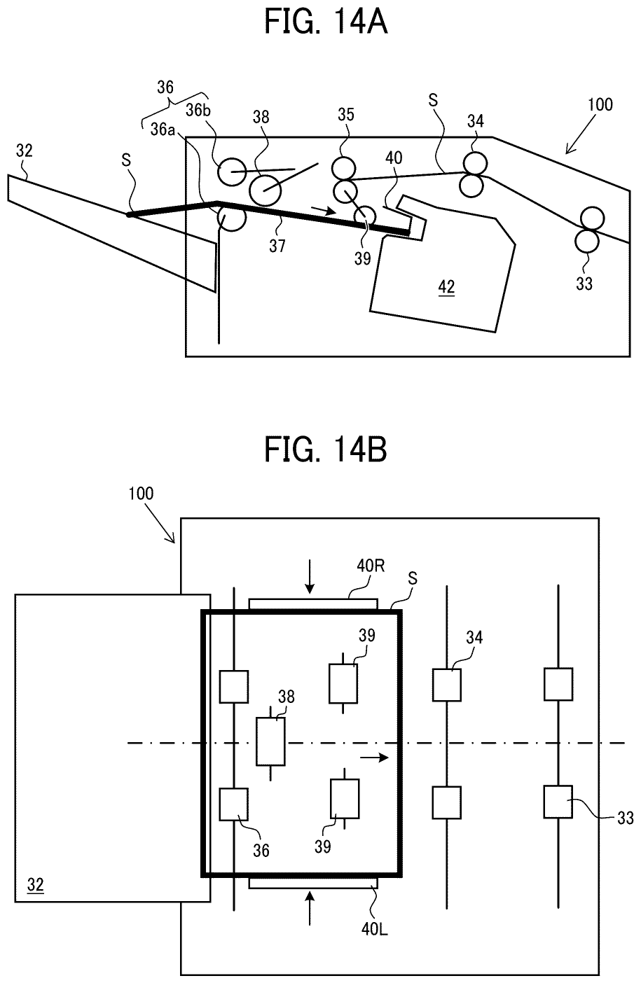

In the present embodiment, the binding processing unit 100 will be described as an example of a post-processing device that performs sheet processes other than the folding process, but a specific example of the post-processing device (post-process) is not limited to the above description. As illustrated in FIG. 5, the binding processing unit 100 includes a binding unit housing 31, a discharge tray 32, a plurality of conveyance roller pairs (a receiving conveyance roller pair 33, a relay conveyance roller pair 34, a shift conveyance roller pair 35 disposed in an internal tray 37, and a discharge conveyance roller pair 36), an internal tray 37, a tapping runner 38, a return runner 39, end fences 40 (40L and 40R), side fences 41 (41L and 41R) (refer to FIG. 14B), and a binding process device 42.

The binding unit housing 31 has a box shape in which an internal space for accommodating components of the binding processing unit 100 is formed. A conveyance passage Ph3 as a space through which the sheet S passes is formed in the internal space of the binding unit housing 31. The discharge tray 32 is supported on an outer surface of the binding unit housing 31. The discharge tray 32 supports the sheet S or the sheet bundle Sb conveyed by the receiving conveyance roller pair 33, the relay conveyance roller pair 34, the shift conveyance roller pair 35, and the discharge conveyance roller pair 36.

The receiving conveyance roller pair 33, the relay conveyance roller pair 34, the shift conveyance roller pair 35, and the discharge conveyance roller pair 36 are disposed at positions at a predetermined interval along the conveyance passage Ph3. In other words, the sheet S received by the binding processing unit 100 is conveyed along the conveyance passage Ph3 by the receiving conveyance roller pair 33, the relay conveyance roller pair 34, the shift conveyance roller pair 35, and the discharge conveyance roller pair 36.

A basic configuration of the receiving conveyance roller pair 33, the relay conveyance roller pair 34, the shift conveyance roller pair 35, and the discharge conveyance roller pair 36 is the same as that of the conveyance roller pair 22 of the folding processing unit 200. The discharge conveyance roller pair 36 includes a discharge driving roller 36a and a discharge driven roller 36b that can contact and separate from the discharge driving roller 36a. The shift conveyance roller pair 35 may be slidable in a width direction in order to implement a sorting process in which the sheet S is shifted in the width direction and discharged to the discharge tray 32.

The internal tray 37 temporarily supports (stacks) the plurality of sheets S sequentially conveyed on the conveyance passage Ph3. The tapping runner 38 is supported at a tip end of a rotation arm above the internal tray 37. When the rotation arm rotates, the tapping runner 38 supplies the sheet S interposed by the discharge conveyance roller pair 36 to the internal tray 37. The return runner 39 abuts an upper surface of the sheet S supported by the internal tray 37 and rotates, thereby guiding the sheet S toward the end fences 40 (40L and 40R).

The end fences 40 (40L and 40R) abut a downstream end in the conveyance direction of the sheet S supported by the internal tray 37 to align a position of the sheet S in the conveyance direction. The side fences 41 (41L and 41R) abut both ends in the width direction of the sheet S supported by the internal tray 37 to align a position of the sheet S in the width direction. The binding process device 42 performs the binding process of binding the sheet bundle Sb supported by the internal tray 37. The binding process performed by the binding process device 42 may be a staple binding process of inserting a binding staple into the sheet bundle Sb to bind or a pressure binding process of binding by deforming the sheet bundle Sb under pressure. The binding processing unit 100 may include a staple binding process device that performs the staple binding process and a pressure binding process device that performs the pressure binding process, which are operable independently of each other at positions spaced apart from each other in the width direction.

### Hardware Configuration of MFP

A description is given of a hardware configuration of the binding processing unit 100 included in the MFP 1, with reference to FIG. 6. A hardware configuration including the punching processing unit 400 will not be described. As illustrated in FIG. 6, the binding processing unit 100 includes a central processing unit (CPU) 110 as a controller, and is connected to a plurality of motors serving as power sources for operation of each mechanism via an interface (I/F) 120. The CPU 110 serves as an arithmetic unit and controls an entire operation of the binding processing unit 100.

The CPU 110 in the binding processing unit 100 is connected to the image forming controller 308 of the MFP 1 via the I/F 120, and controls the binding processing unit 100 according to a processing signal from the MFP 1. The binding processing unit 100 is an optional device and thus has a detachably attachable hardware configuration.

An I/F for connection between the image forming device 300 and the binding processing unit 100 includes, for example, a relay connector or a drawer connector that enables a detachably attachable hardware configuration. An I/F for connection between the punching processing unit 400 and the image forming device 300 has a similar configuration.

A drive motor that drives a plurality of conveyance roller pairs for performing the binding process in the binding processing unit 100 is equipped with an encoder enabling detection of an amount of driving of each motor based on the number of pulses. The conveyance roller pair can be driven or stopped at a position corresponding to a specific amount of driving with a specific timing as a base point, leading to implementation of control of conveying the sheet S by a predetermined amount in a predetermined direction.

It is possible to measure an encoder pulse with a timing at which a sensor on the conveyance passage is turned ON or OFF as a base point, and calculate the amount of driving of each motor based on the encoder pulse. A position of an end of the sheet S being conveyed can be detected based on the calculated amount of driving.

As illustrated in FIG. 6, in the binding controller 102, which is a controller of the binding processing unit 100, a sheet conveyance motor 151, a sheet ejection motor 152, a stapler drive motor 153, a sheet conveyance sensor 154, a sheet ejection sensor 155, and a stapler movement home position (HP) sensor 156 are connected to the CPU 110 via the I/F 120.

In the folding controller 202, which is a controller of the folding processing unit 200, a folding motor 162, an entrance sensor 163, and a folding sensor 164 are connected to the CPU 110 via the I/F 121.

When a punching processing unit that performs a punching process on the sheet S is optionally connected, in a controller of the punching processing unit, a hole punch motor 157, a punch movement motor 158, a pre-punch motor 159, a cover open-close sensor 160, and a hole punch unit home position (HP) sensor 161 are connected to the CPU 110 via the I/F 122.

### First Operation Example of Binding Processing Unit

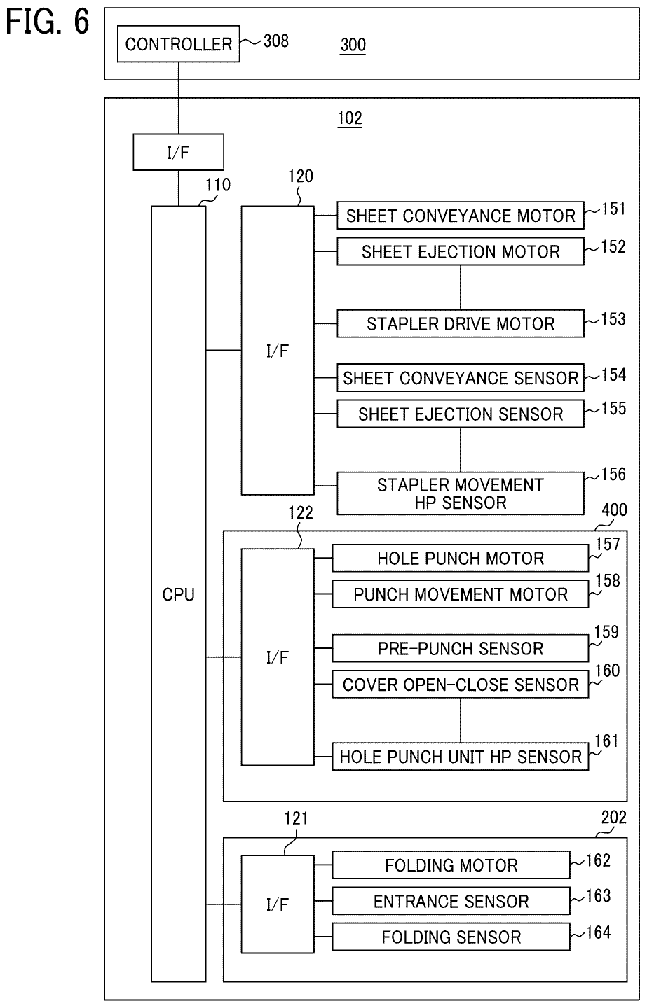

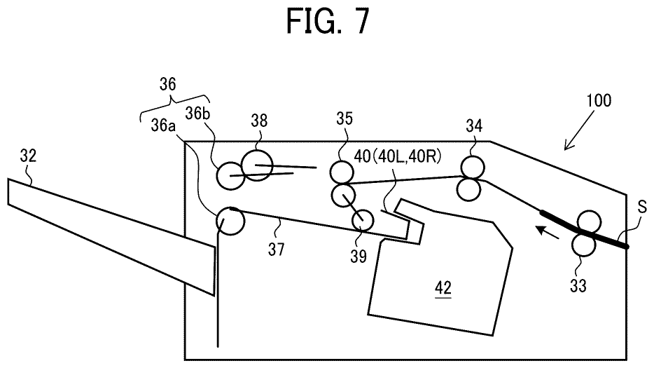

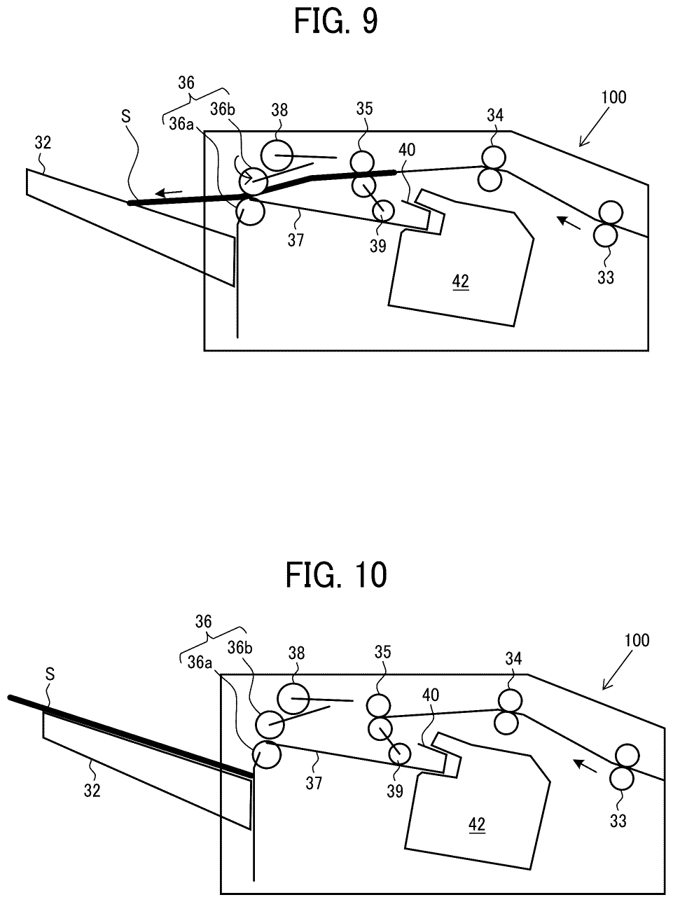

A description is given of a first operation example in the binding processing unit 100. Movement of the sheet S when a shift discharge mode for shifting the sheet S in the width direction in the conveyance direction to discharge is performed in the binding processing unit 100 will be described with reference to FIGS. 7 to 10.

As illustrated in FIG. 7, the paper conveyed from the image forming device 300 is received in the binding processing unit 100 and conveyed along the conveyance passage Ph3 by the receiving conveyance roller pair 33.

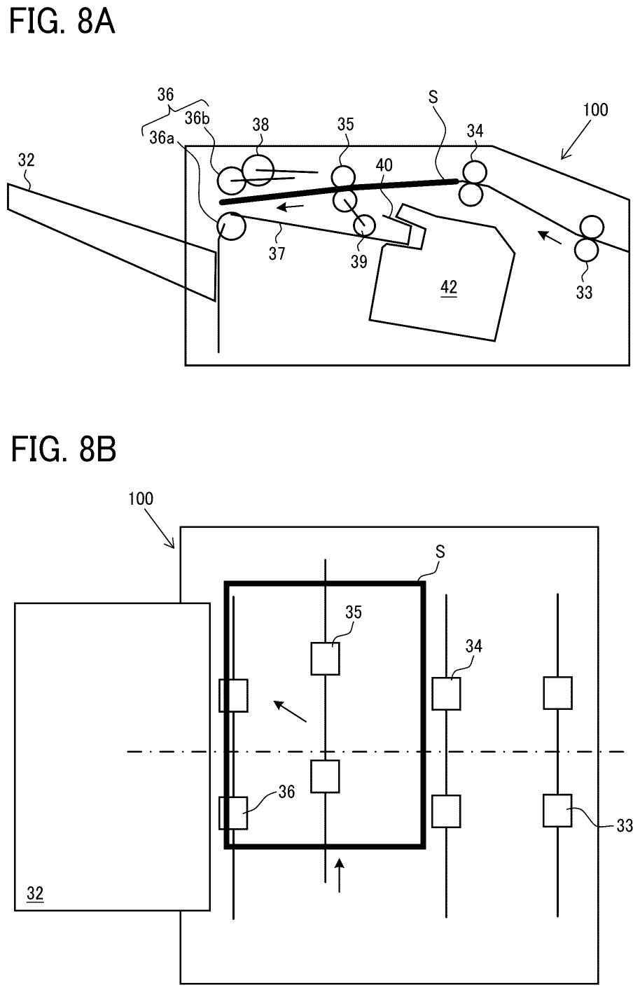

Subsequently, as illustrated in FIG. 8A, the conveyance is continued until the discharge driven roller 36b of the discharge conveyance roller pair 36 is located in a nip pressure release state and a rear end of the sheet S in the conveyance direction passes through the relay conveyance roller pair 34. As illustrated in FIG. 8B, by conveying the sheet S while moving the shift conveyance roller pair 35 in a direction (width direction) orthogonal to the conveyance direction of the sheet S, the sheet S can be conveyed while being shifted in the width direction. In the example of FIG. 8B, the sheet S is moved from the center to a back side of the conveyance passage Ph3 when viewed from the front (FIG. 5) of the binding processing unit 100.

The shift conveyance roller pair 35 is not limited to the movement to the back side as described above, and can also move from the center to a front side of the conveyance passage Ph3 in the binding processing unit 100 in the opposite direction. When a plurality of sheets S is continuously conveyed, it is possible to switch whether to move (shift) or the moving direction for each sheet. The moving direction may be switched in units of sheets S forming the sheet bundle Sb. A process of discharging to the discharge tray 32 in a state of being moved (shifted) in the conveyance direction by the shift conveyance roller pair 35 is sometimes referred to as a sorting process.

Subsequently, at a timing when the shift of the sheet S is completed, the discharge driven roller 36b of the discharge conveyance roller pair 36 is moved to the nip position as illustrated in FIGS. 8A and 8B. The sheet S is conveyed toward the discharge tray 32 by the discharge conveyance roller pair 36.

As described above, the sheet S is discharged to the discharge tray 32 by a series of operations as illustrated in FIG. 10. In the above description, an example of the sheet S is described taking the same as paper. As already described, the folding processing unit 200 might be present upstream the binding processing unit 100. The binding processing unit 100 can also convey and discharge the sheet S subjected to the folding process in the folding processing unit 200 as described above.

### Second Operation Example of Binding Processing Unit

A description is given of a second operation example in the binding processing unit 100.

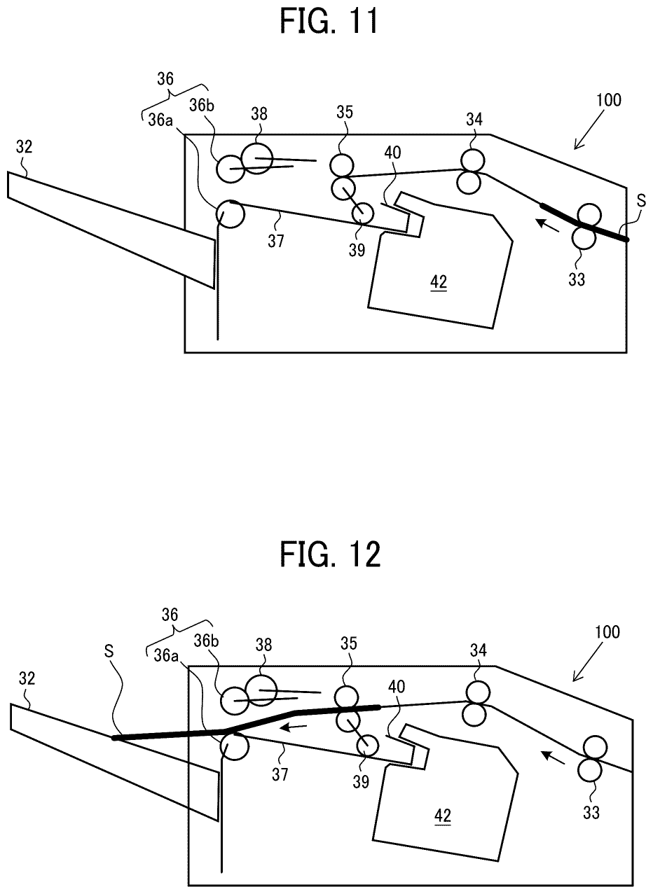

A description will be given of movement of the sheet S when performing a binding discharge mode of bundling a plurality of sheets S and performing the binding process on the sheet bundle Sb to discharge in the binding processing unit 100 with reference to FIGS. 11 to 16.

Similarly to the shift conveyance mode already described, first, as illustrated in FIG. 11, the paper conveyed from the image forming device 300 is received in the binding processing unit 100 and conveyed along the conveyance passage Ph3 by the receiving conveyance roller pair 33.

Subsequently, as illustrated in FIG. 12, the discharge driven roller 36b of the discharge conveyance roller pair 36 is located in the nip pressure release state, and the sheet S is conveyed toward the internal tray 37 without the shift conveyance by the shift conveyance roller pair 35.

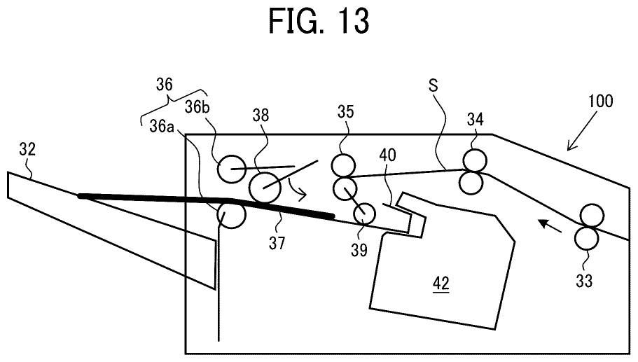

Subsequently, as illustrated in FIG. 13, in a situation in which the sheet S is conveyed to the internal tray 37 by the shift conveyance roller pair 35, the tapping runner 38 rotates to tap the sheet S from the conveyance passage Ph3 toward the internal tray 37 to move the position. The sheet S is conveyed in a direction toward the end fences 40 by an action of the operation of the tapping runner 38. This conveyance is referred to as “switchback conveying”.

Subsequently, as illustrated in FIG. 14A, the sheet S is switchback conveyed toward the end fences 40 by the action of the tapping runner 38 and the return runner 39. As illustrated in FIG. 14B, after abutting the end fences 40, the sheet S is interposed by the side fences 41 to align the end of the sheet S in the width direction.

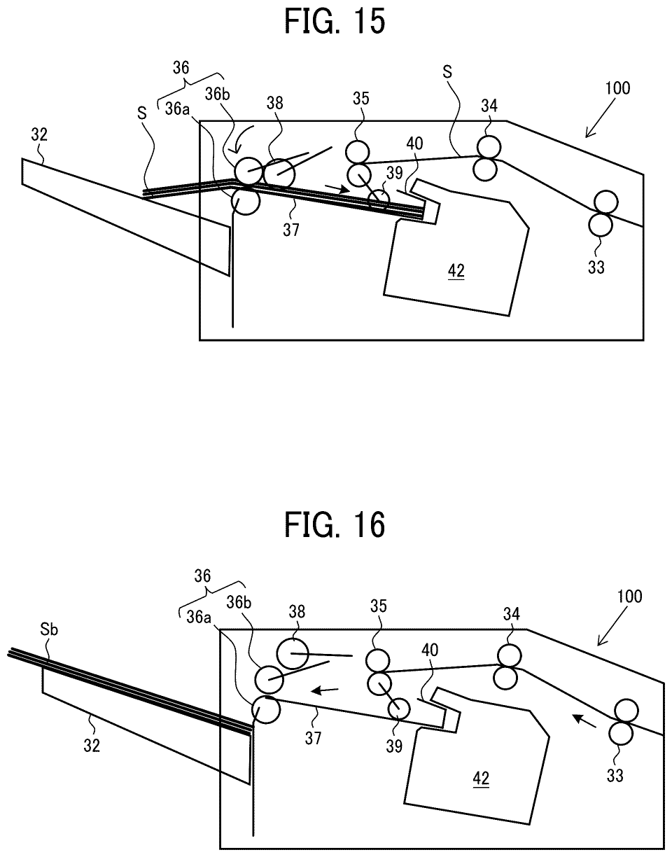

By repeating the operation illustrated in FIGS. 11 to 14B, a predetermined number of sheets S are stacked on the internal tray 37. By driving the binding process device 42 in a state in which the number of sheets S for forming the sheet bundle Sb is stacked, the sheet bundle Sb supported by the internal tray 37 is bound. Then, as illustrated in FIG. 15, the binding processing unit 100 allows the discharge driving roller 36a and the discharge driven roller 36b to interpose the sheet bundle Sb. Then, the binding processing unit 100 rotates the discharge conveyance roller pair 36 and the return runner 39 in the forward direction, thereby discharging the sheet bundle Sb to the discharge tray 32.

As described above, the sheet bundle Sb is discharged to the discharge tray 32 by a series of operations as illustrated in FIG. 16. In the above description, an example of the sheets S forming the sheet bundle Sb is described taking the same as paper. As already described, the folding processing unit 200 might be present upstream the binding processing unit 100. The binding processing unit 100 can form the sheet bundle Sb of the sheets S subjected to the folding process in the folding processing unit 200, and convey to discharge as described above.

### Another Example of Configuration of Folding Processing Unit

As illustrated in FIG. 5, the folding processing unit 200 performs the folding process with three folding rollers (the first folding roller 23, the second folding roller 24, and the third folding roller 25), but may perform the folding process with four folding rollers (the first folding roller 23, the second folding roller 24, the third folding roller 25, and a fourth folding roller 29) as illustrated in FIG. 17. Hereinafter, a description will be given based on the configuration illustrated in FIG. 5.

### First Operation Example of Folding Processing Unit

A description is given of a flow of an operation when performing the “Z-fold” in the folding processing unit 200.

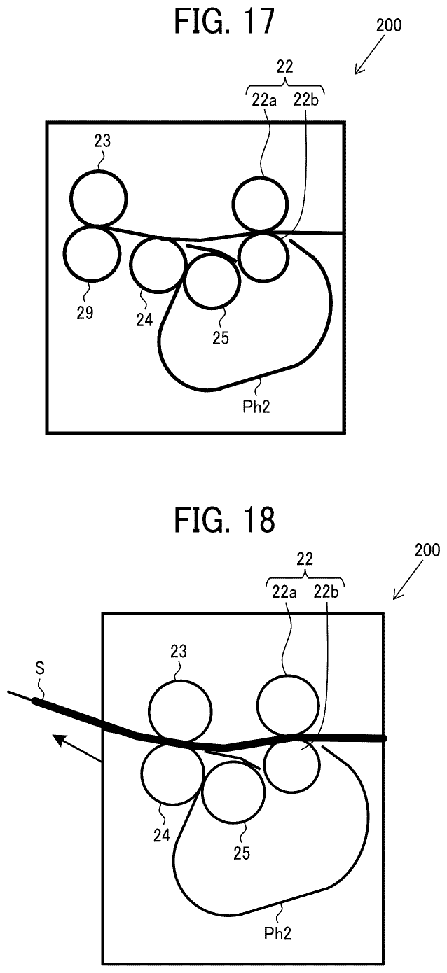

As illustrated in FIG. 18, when the sheet S is conveyed from an upstream device (the image forming device 300), the sheet S is received by the conveyance roller pair 22. The conveyance roller pair 22, the first folding roller 23, and the second folding roller 24 convey the sheet S from the upstream to the downstream of the main conveyance passage Ph1. At that time, the guide plate 26 is in the first posture for guiding the sheet S to the nip between the first folding roller 23 and the second folding roller 24.

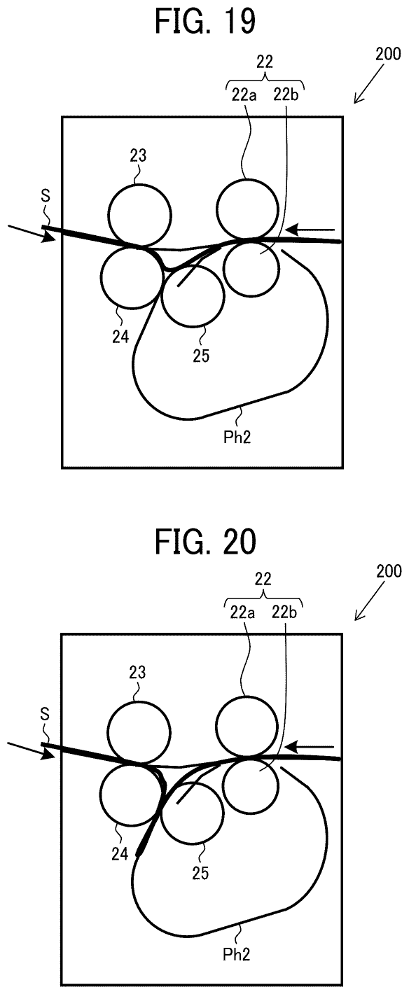

Subsequently, as illustrated in FIG. 19, the conveyance roller pair 22 allows reverse rotation of the first folding roller 23 and the second folding roller 24 while conveying the sheet S on the upstream side of the branch position A in the downstream direction by normal rotation. As a result, a portion of the sheet S that has exceeded the nip between the first folding roller 23 and the second folding roller 24 toward the downstream side is returned to the branch position A (upstream side). At that time, the guide plate 26 is in the second posture. As a result, bending of the sheet S is formed toward the nip between the second folding roller 24 and the third folding roller 25.

Subsequently, as illustrated in FIG. 20, both the portion of the sheet S that has exceeded the branch position A and the portion of the sheet S that has not exceeded the branch position A are guided to the nip between the second folding roller 24 and the third folding roller 25 by the normal rotation of the conveyance roller pair 22, and a first folding process is performed. At that time, the guide plate 26 remains in the second posture. The second folding roller 24 and the third folding roller 25 are rollers used only for conveying the folded sheet S.

Subsequently, as illustrated in FIG. 21, the first folding roller 23 and the second folding roller 24 are rotated reversely, and the sheet S is conveyed to the return conveyance passage Ph2 until a leading end of the sheet S exceeds the nip between the first folding roller 23 and the second folding roller 24 while maintaining the normal rotation of the conveyance roller pair 22. At that time, the guide plate 26 remains in the second posture.

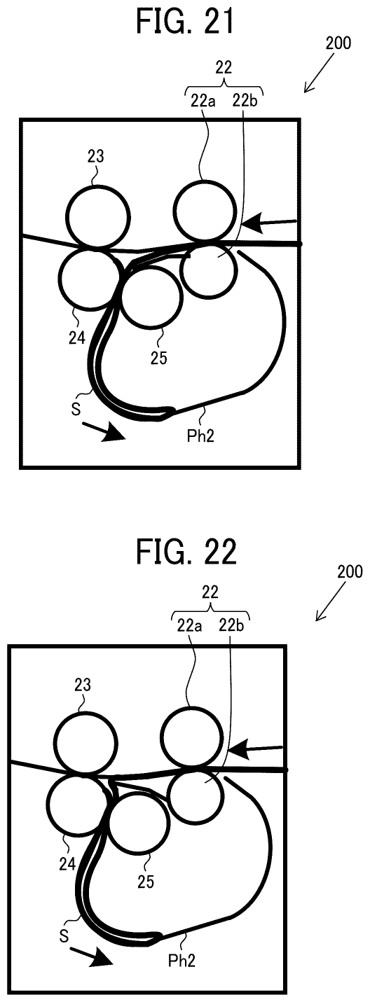

Subsequently, as illustrated in FIG. 22, there is no sheet S at the nip between the first folding roller 23 and the second folding roller 24, and the sheet S is conveyed toward the downstream side by the conveyance roller pair 22. At that time, by returning the guide plate 26 to the first posture, the portion of the sheet S on the upstream side of the branch position A is directed in the direction of the nip between the first folding roller 23 and the second folding roller 24.

Then, as illustrated in FIG. 23, the sheet S is conveyed by the normal rotation toward the binding processing unit 100 by keeping conveying by the normal rotation. At that time, the guide plate 26 returns to a position where the sheet S is guided to the nip between the first folding roller 23 and the second folding roller 24.

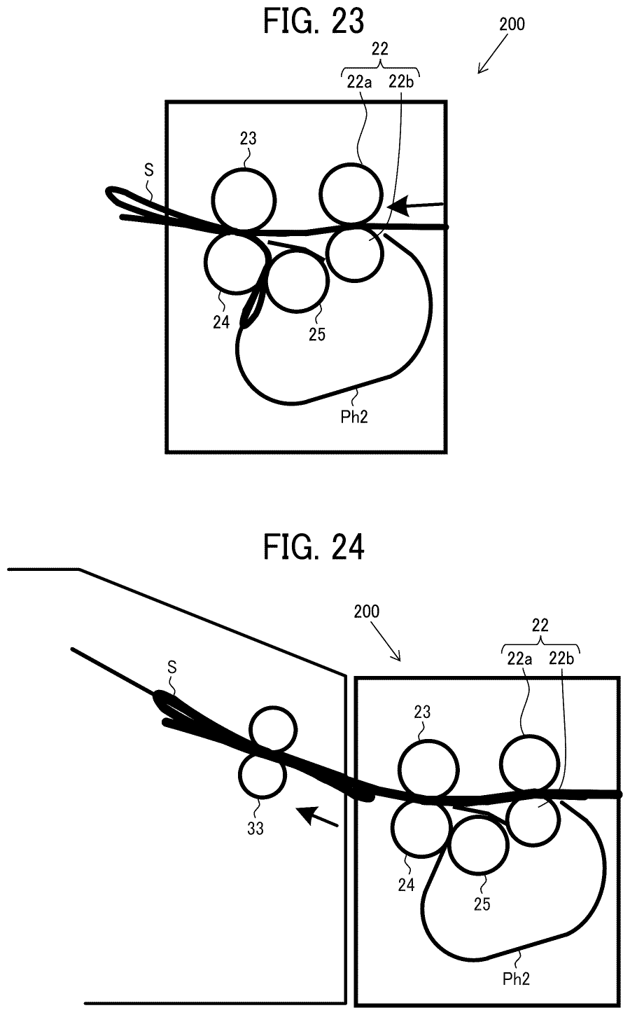

Finally, as illustrated in FIG. 24, the Z-folded sheet S is conveyed to the conveyance passage Ph3 in the binding processing unit 100. At that time, the guide plate 26 is at a position of guiding the sheet to the nip between the first folding roller 23 and the second folding roller 24. A subsequent operation is the process in the binding processing unit 100 as described above.

### Second Operation Example of Folding Processing Unit

A description is given of a flow of an operation when “half-fold” is performed in the folding processing unit 200.

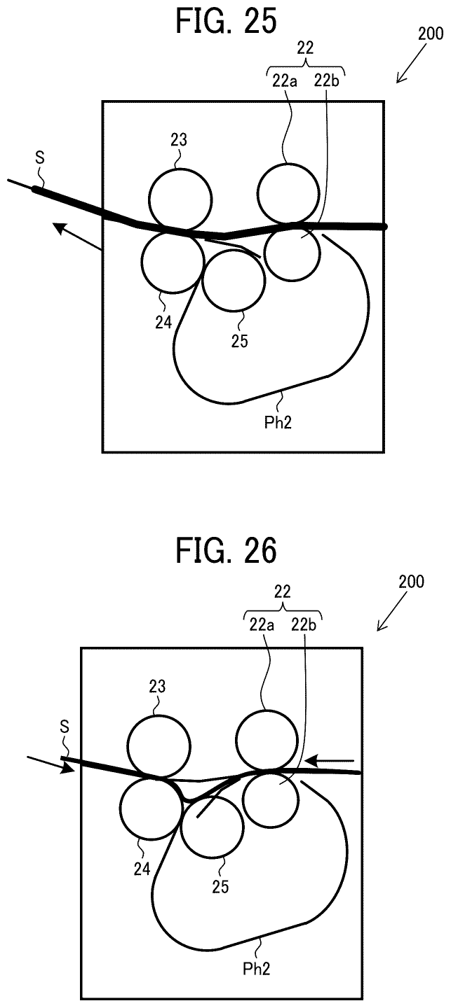

As illustrated in FIG. 25 similar to FIG. 18, when the sheet S is conveyed from the upstream device (image forming device 300), the sheet S is received by the conveyance roller pair 22. The conveyance roller pair 22, the first folding roller 23, and the second folding roller 24 convey the sheet S from the upstream to the downstream of the main conveyance passage Ph1. At that time, the guide plate 26 is at a position of guiding the sheet to the nip between the first folding roller 23 and the second folding roller 24.

Subsequently, as illustrated in FIG. 26 similar to FIG. 19, the first folding roller 23 and the second folding roller 24 are rotated reversely while maintaining the normal rotation of the conveyance roller pair 22. Bending of the sheet S is generated between the conveyance roller pair 22 and the first folding roller 23. At that time, the guide plate 26 is retracted, and is at a position where the bending of the sheet can be guided to the nip between the second folding roller 24 and the third folding roller 25.

Subsequently, as illustrated in FIG. 27 similar to FIG. 19, the bending of the sheet S formed by the normal rotation of the conveyance roller pair 22 and the reverse rotation of the first folding roller 23 and the second folding roller 24 is guided to the nip between the second folding roller 24 and the third folding roller 25, and the folding process is performed. The guide plate 26 remains in the second posture. A fold formed at that time is referred to as a “proper fold f”.

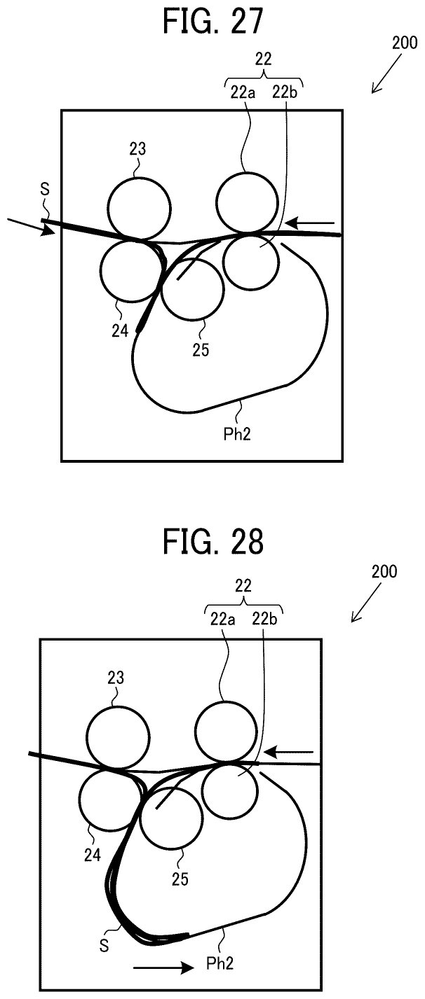

Subsequently, as illustrated in FIG. 28, the sheet S folded by the normal rotation of the conveyance roller pair 22 and the reverse rotation of the first folding roller 23 and the second folding roller 24 is conveyed in the direction of the nip of the conveyance roller pair 22 on the return conveyance passage Ph2. At that time, the guide plate 26 remains in the second posture.

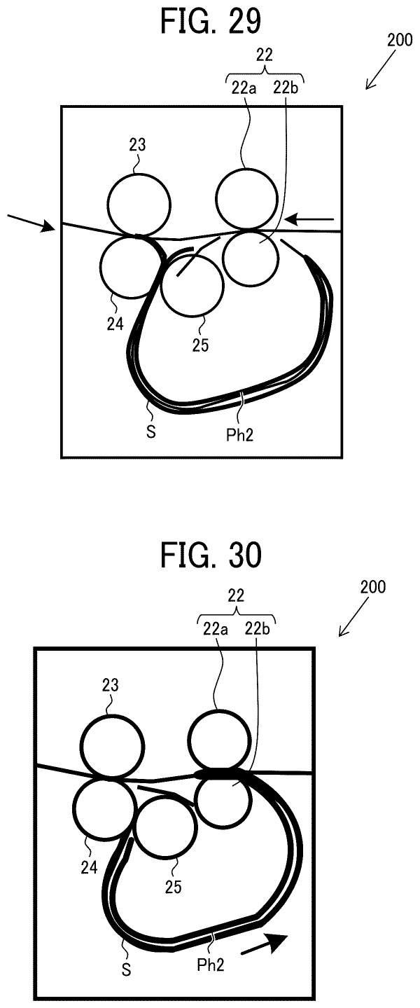

Subsequently, as illustrated in FIG. 29, the sheet S is conveyed along the return conveyance passage Ph2 toward the nip of the conveyance roller pair 22 and returned to the joining position B. At that time, the guide plate 26 remains in the second posture.

Subsequently, as illustrated in FIG. 30, at a timing when the rear end of the sheet S passes through the nip between the second folding roller 24 and the third folding roller 25, the second folding roller 24 and the third folding roller 25 are returned from the reverse rotation to the normal rotation. The guide plate 26 is returned from the second posture to the first posture. As a result, the sheet S conveyed by the conveyance roller pair 22 (the sheet S subjected to a half-fold process) is conveyed downstream in the conveyance direction.

Subsequently, as illustrated in FIG. 31, the sheet S returned to the joining position B is received by the nip of the conveyance roller pair 22 and conveyed toward the binding processing unit 100.

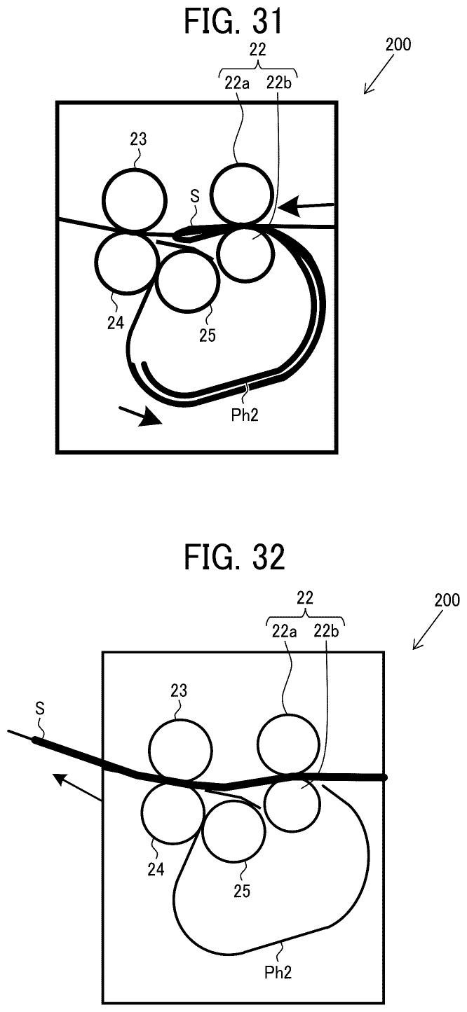

Finally, as illustrated in FIG. 32, the sheet S subjected to half-fold is conveyed to the conveyance passage Ph3 in the binding processing unit 100. At that time, the guide plate 26 is at a position of guiding the sheet to the nip between the first folding roller 23 and the second folding roller 24. A subsequent operation is the process in the binding processing unit 100 as described above.

Supplementary Description regarding Box-Fold

A description is given of “box-fold” of which occurrence can be suppressed in the folding processing unit 200 according to the present embodiment, with reference to the drawings.

A case where “half-fold” is performed as in the series of folding processes in FIGS. 25 to 32 will be described as an example. In the folding processing unit 200, when the sheet S (subjected to the half-fold process) passes through the return conveyance passage Ph2, returns to the joining position B, and passes through the conveyance roller pair 22, it is correct that the fold (proper fold f) is the head at the time of entering the nip of the conveyance roller pair 22.

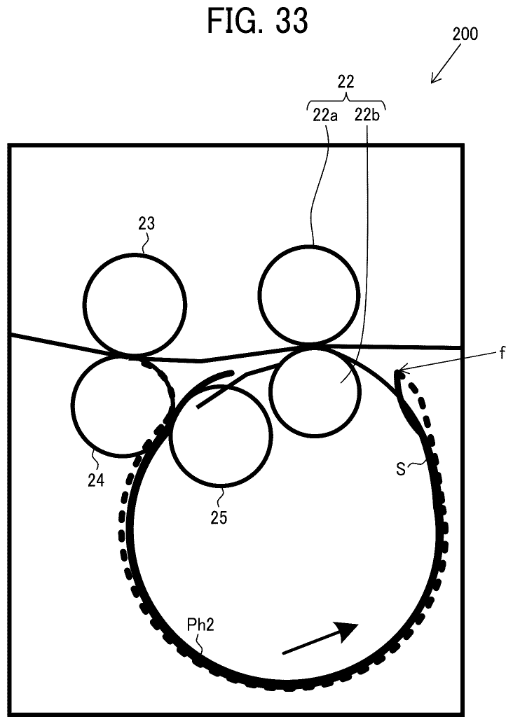

FIG. 33 illustrates a state in which the sheet S subjected to the half-fold on which the proper fold f is formed is being conveyed through the return conveyance passage Ph2 having a curvature. As illustrated in FIG. 33, in the sheet S conveyed through the return conveyance passage Ph2, the proper fold f starts deviating from the head in the conveyance direction. This is because it puts into a situation in which relative conveyance distances of one piece and the other piece of the sheet S with the proper fold f as a boundary are different before returning to the joining position B due to the conveyance passage gap “g” and the curvature of the return conveyance passage Ph2.

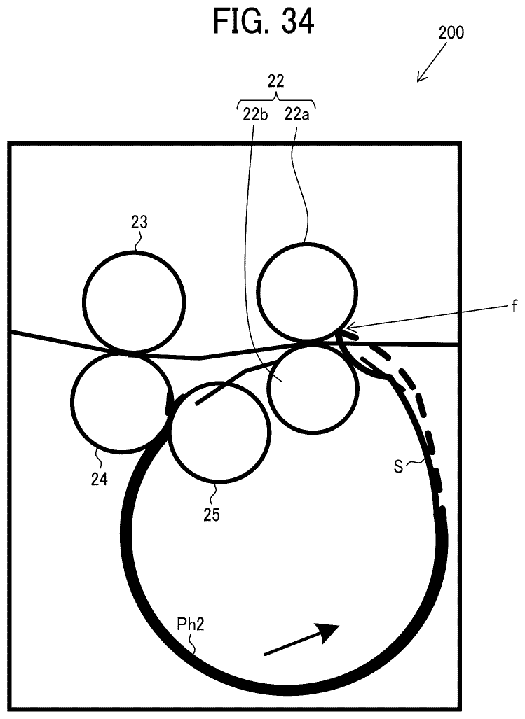

As a result, as illustrated in FIG. 34, it returns to the joining position B in a state in which the position of the proper fold f deviates from the head in the conveyance direction, and then, the sheet S enters the nip of the conveyance roller pair 22. In this case, the head in the conveyance direction is not the proper fold f, and the vicinity of the proper fold fis the head in the conveyance direction. It enters the nip of the conveyance roller pair 22 in a state in which one piece in the vicinity of the proper fold f remains bulging in the nip direction.

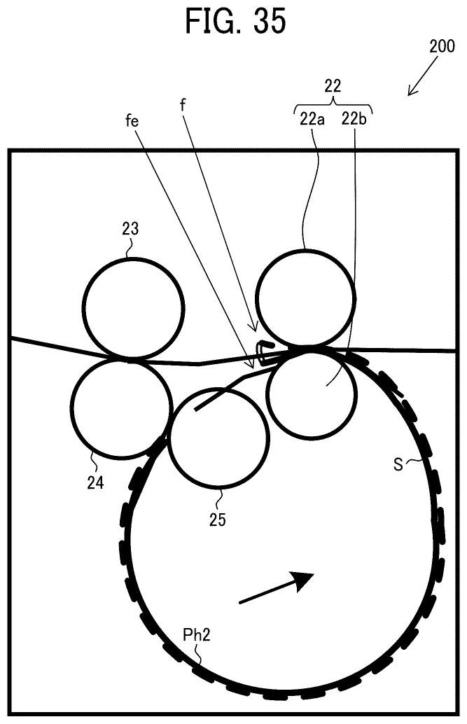

As illustrated in FIG. 35, a portion other than the proper fold f passes through the nip of the conveyance roller pair 22 to form a fold. A second fold formed in this manner is referred to as an “improper fold fe”. In this manner, the improper fold “fe” different from the originally intended proper fold f is formed in either piece of the sheet S, and the originally formed proper fold f and the improper fold “fe” are formed in the vicinity, so that a part of the sheet S is folded twice. Such a folded state is referred to as “box-fold”.

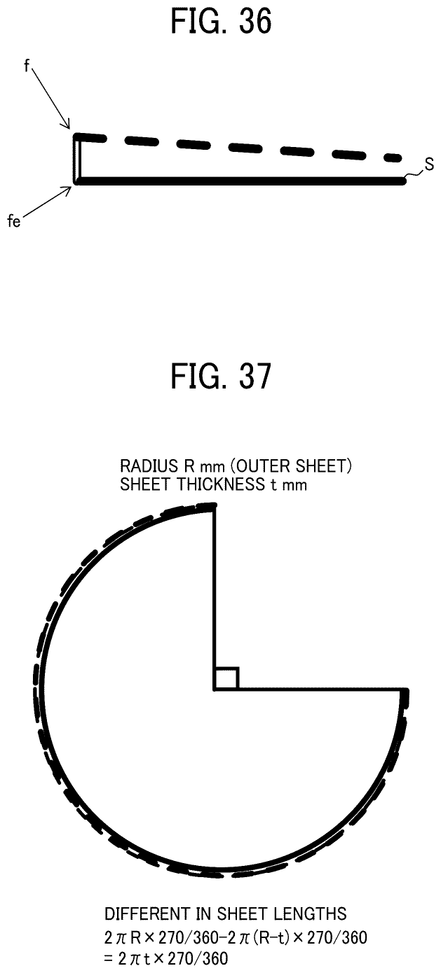

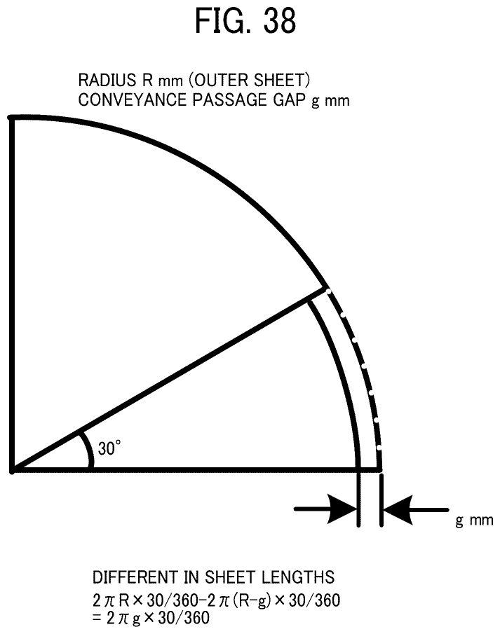

FIG. 36 is an enlarged view of a portion of the box-fold. A situation in which although only the proper fold “f” should be formed originally, the improper fold “fe” is formed in the vicinity of the proper fold “f”′ is the “box-fold”.

The return conveyance passage Ph2 illustrated in FIGS. 33 to 36 is expressed in an arc shape in order to simplify the illustration.

In FIGS. 33 to 36, a piece conveyed on an inner peripheral side of the curvature of the return conveyance passage Ph2 is referred to as an “inner piece” out of two pieces on both sides of the fold of the sheet S when being conveyed through the return conveyance passage Ph2. Similarly, a piece conveyed on an outer peripheral side is referred to as an “outer piece”. The inner piece is drawn by a solid line, and the outer piece is drawn by a broken line.

The half-folded sheet S is conveyed in a state in which the inner piece and the outer piece are in close contact with each other at a portion other than the vicinity of the proper fold f at the beginning of conveyance on the return conveyance passage Ph2. There hardly is an influence of the difference in conveyance distance due to the thickness (thickness dimension) of the sheet S. However, since the inner piece and the outer piece are not in close contact with each other in the vicinity of the proper fold f, there is an influence of the difference in conveyance distance between the inner piece and the outer piece. Mainly, as illustrated in FIG. 31, since the conveyance distance of the inner piece is shorter than that of the outer piece, a relative conveyance direction length (length) of the sheet S is longer in the inner piece than in the outer piece. As a result, the proper fold f faces an outer peripheral direction of the return conveyance passage Ph2.

In the state illustrated in FIG. 34 subsequent to FIG. 33, the sheet S enters the nip of the conveyance roller pair 22 with the proper fold f facing outward. As a result, as illustrated in FIG. 35, the improper fold “fe” is formed at a position different from the position of the proper fold f formed by the second folding roller 24 and the third folding roller 25.

FIG. 34 is an enlarged view of the vicinity of the proper fold f of the sheet S after the sheet S passes through the conveyance roller pair 22 as illustrated in FIG. 33. As illustrated in FIG. 34, due to the influence of the curvature of the return conveyance passage Ph2, a difference occurs in the conveyance distance between the inner piece and the outer piece, and the inner piece is relatively long with respect to the outer piece, so that the improper fold “fe” is formed in addition to the proper fold f, and is folded in the box shape. The box-fold causes deterioration in quality of the folding process.

Here, a difference in conveyance passage length due to the return conveyance passage Ph2 that causes the box-fold will be described. The following description is based on the difference in apparent length in the conveyance direction (length dimension of each piece of the sheet S) occurring between the inner piece and the outer piece of the sheet S due to the difference in conveyance passage length. Hereinafter, the difference in relative length between the pieces is referred to as a “sheet length difference”.

The return conveyance passage Ph2 already illustrated is not originally formed only of an arc because there is a partial straight line, but there is no curvature in the straight line portion and no sheet length difference occurs, so that this can be ignored and considered.

When a circle corresponding to the curvature of an arc portion of the return conveyance passage Ph2 is assumed, a radius of the virtual circle is R [mm], and the arc of the return conveyance passage Ph2 is 270°. The thickness (thickness dimension) of the sheet S is defined as “sheet thickness “t” [mm] “. The “conveyance passage gap “g” [mm] “, which is a dimension of a passage gap for the sheet S to pass through the return conveyance passage Ph2, is set.

In this case, the sheet length difference between the inner piece and the outer piece when conveyed through the return conveyance passage Ph2 is defined as “2Tπ×270/360−2π(R−t)×270/360”. The expression is simplified as “2πt×270/360”.

Assuming that the sheet thickness “t”=0.1 [mm], the sheet length difference of the close contact portion between the inner piece and the outer piece of the sheet S is about “0.4713”. As the numerical value of the sheet thickness “t” increases, the numerical value of the sheet length difference increases.

As illustrated in FIG. 36, based on the above, when the return conveyance passage Ph2 is assumed in a range in which the arc angle is 30° in R, the sheet difference length other than the close contact portion between the inner piece and the outer piece is defined as “2πg×3/360”. Assuming that the conveyance passage gap “g” is 5 [mm], the sheet length difference is about 2.62 [mm]. When a sheet length difference due to the sheet thickness “t” is added to this, a sheet length difference of about 3.1 [mm] occurs when the sheet S is conveyed through the return conveyance passage Ph2 and returns to the joining position B. The larger the value of the conveyance passage gap “g”, the larger the numerical value of the sheet length difference.

As described above, when it is conveyed using the return conveyance passage Ph2 with the proper fold f formed by the second folding roller 24 and the third folding roller 25 at the head, the position of the proper fold f deviates with respect to the nip of the conveyance roller pair 22 due to the influence of the curvature. This deviation is caused by the influence of the sheet thickness “t” and the conveyance passage gap “g”, and is assumed to be a deviation of about several mm.

As a result, the box-fold described above occurs. The numerical values used for the calculation of the sheet length difference are virtual. Since the curvature of the return conveyance passage Ph2 is not one, a slight change is assumed in a case where the sheet length difference is calculated based on the above expression.

### First Embodiment

A description is given of a first embodiment of a sheet processing apparatus according to the present disclosure.

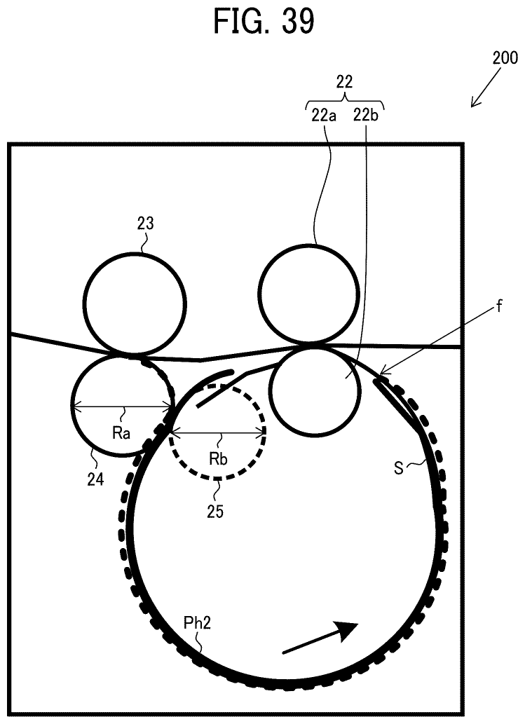

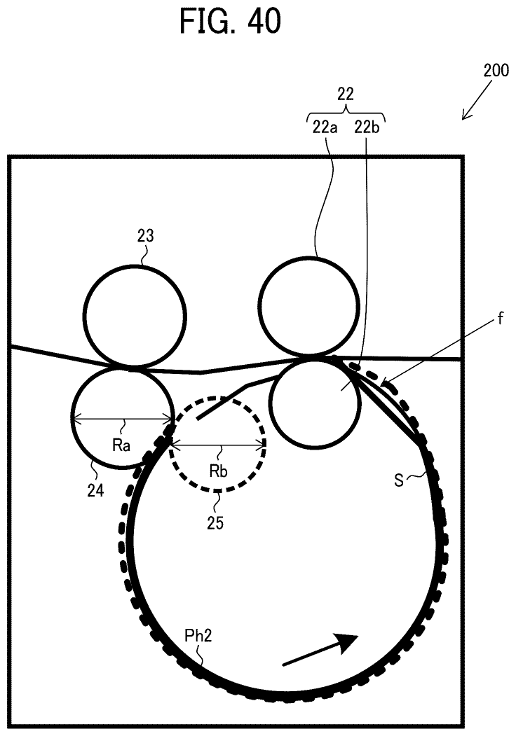

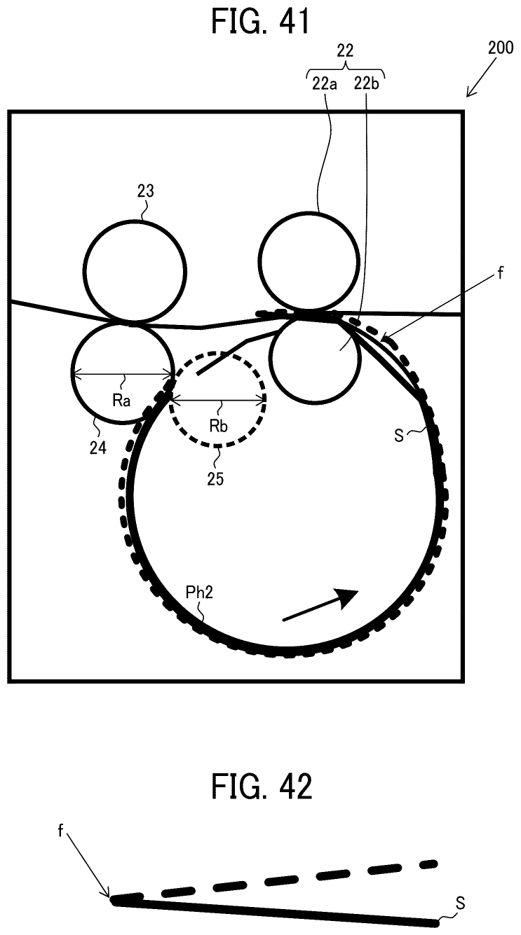

FIGS. 39 to 41 are diagrams for illustrating a configuration and an operation of a folding processing unit 200 according to the present embodiment.

In a case where a third folding roller 25 is also rotationally driven by a drive source that rotates a second folding roller 24 according to the present embodiment, when the number of teeth of gears coupling the rollers to each other is the same, a rotation speed of the second folding roller 24 and the third folding roller 25 is the same.

The present embodiment assumes a case where the rotation speed of the second folding roller 24 and the third folding roller 25 is the same. In this case, assuming that a roller diameter of the second folding roller 24 as an outer peripheral roller is “Ra” and a roller diameter of the third folding roller 25 as an inner peripheral roller is “Rb”, when Ra=Rb is satisfied, a conveyance amount of an outer piece conveyed by the second folding roller 24 and a conveyance amount of an inner piece conveyed by the third folding roller 25 are the same. In this case, as already described, it is not possible to cause a difference in conveyance amount that offsets a sheet length difference at the time of conveyance through a return conveyance passage Ph2, and a box-fold occurs.

For this reason, in the present embodiment, the roller diameter “Ra” of the second folding roller 24 is made larger than the roller diameter “Rb” of the third folding roller 25. In other words, the roller diameters of the second folding roller 24 and the third folding roller 25 are set so as to satisfy a relationship of “Ra>Rb”. Accordingly, the conveyance amount of the inner piece by the third folding roller 25 is made smaller than the conveyance amount of the outer piece by the second folding roller 24. As a result, as illustrated in FIGS. 39 to 41, when a sheet S reaches a nip of a conveyance roller pair 22, a nip position and a position of a proper fold f are aligned.

When the nip position and the position of the proper fold f are aligned, a folding process can be performed on the sheet S (sheet S subjected to the folding process) having passed through the nip of the conveyance roller pair 22 without occurrence of the box-fold as illustrated in FIG. 42.

Assume that Ra=φ20 [mm] and Rb=φ19.8 [mm]. In this case, a circumferential length of the second folding roller 24 is “π×20=62.832 [mm]”. A circumferential length of the third folding roller 25 is “π×19.8=62.204 [mm]”. The sheet length difference can be absorbed by a difference in circumferential length due a difference in roller diameter. Since the conveyance amount per rotation is determined by the roller diameter, it is sufficient to determine the roller diameters of the second folding roller 24 and the third folding roller 25 based on the conveyance amount (required conveyance amount) by a conveyance portion having the curvature of the return conveyance passage Ph2.

In a case where a sheet thickness “t” and a conveyance passage gap “g” are large and the sheet length difference is large, it is sufficient to increase a difference between the roller diameter “Ra” of the second folding roller 24 and the roller diameter “Rb” of the third folding roller 25 to increase the difference in conveyance amount between the roller diameter “Ra” and the roller diameter “Rb”.

### Second Embodiment

A description is given of a second embodiment of a sheet processing apparatus according to the present disclosure.

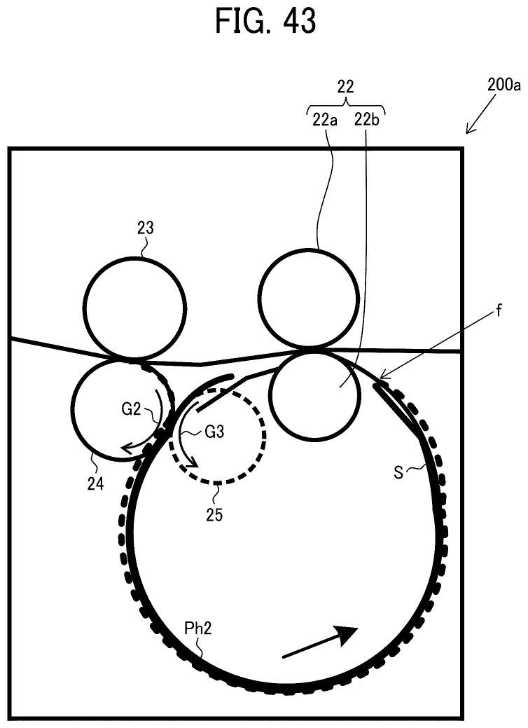

FIG. 43 is a diagram for illustrating a configuration and an operation of a folding processing unit 200a according to the present embodiment.

In a case where a third folding roller 25 is also rotationally driven by a drive source that rotates a second folding roller 24 according to the present embodiment, when a diameter of the second folding roller 24 and that of the third folding roller 25 are the same, there is no difference in conveyance amount.

Assume that the number of teeth of a second folding gear, which is a gear for transmitting a driving force from the drive source to the second folding roller 24, is “G2”, and the number of teeth of a third folding gear, which is a gear for transmitting the driving force to the third folding roller 25, is “G3”. In a case where the gears satisfying G2=G3 are used, a conveyance amount of an outer piece conveyed by the second folding roller 24 and a conveyance amount of an inner piece conveyed by the third folding roller 25 are the same. In this case, as already described, it is not possible to cause a difference in conveyance amount that offsets a sheet length difference at the time of conveyance through a return conveyance passage Ph2, and a box-fold occurs.

For this reason, in the present embodiment, the number of teeth “G2” of the second folding gear that drives the second folding roller 24 is made smaller than the number of teeth “G3” of the third folding gear that drives the third folding roller 25. In other words, the numbers of teeth of the gears for transmitting the driving force to the second folding roller 24 and the third folding roller 25 are set so as to satisfy a relationship of “G2<G3”.

Accordingly, the conveyance amount of the inner piece by the third folding roller 25 is made smaller than the conveyance amount of the outer piece by the second folding roller 24. As a result, as illustrated in FIG. 43, when a sheet S reaches a nip of a conveyance roller pair 22, a nip position and a position of a proper fold f are aligned.

When the nip position and the position of the proper fold f are aligned, a box-fold does not occur in the sheet S (sheet S subjected to the folding process) having passed through the nip of the conveyance roller pair 22 as illustrated in FIG. 42.

Assume that Ra=φ20 [mm] and Rb=φ20 [mm]. Assume that G2=60 and G3=61. The conveyance amount of the outer piece per rotation by the second folding roller 24 is “π×20×60/60=62.832 [mm]”. The conveyance amount of the inner piece per rotation by the third folding roller 25 is “π×20×60/61=61.802 [mm]”. The sheet length difference can be absorbed by the difference in conveyance amount due to the difference in the number of teeth.

Since the conveyance amount per rotation is determined by the roller diameter, it is sufficient to determine a reduction ratio by the number of teeth “G2” of the gear for rotationally driving the second folding roller 24 and the number of teeth “G3” of the gear for rotationally driving the third folding roller 25 based on the conveyance amount (required conveyance amount) by the conveyance portion having the curvature of the return conveyance passage Ph2.

In a case where a sheet thickness “t” and a conveyance passage gap “g” are large and the sheet length difference is large, it is sufficient to increase the difference in conveyance amount by increasing the difference between G2 and G3 (difference in the number of teeth).

### Third Embodiment

A description is given of a third embodiment of a sheet processing apparatus according to the present disclosure.

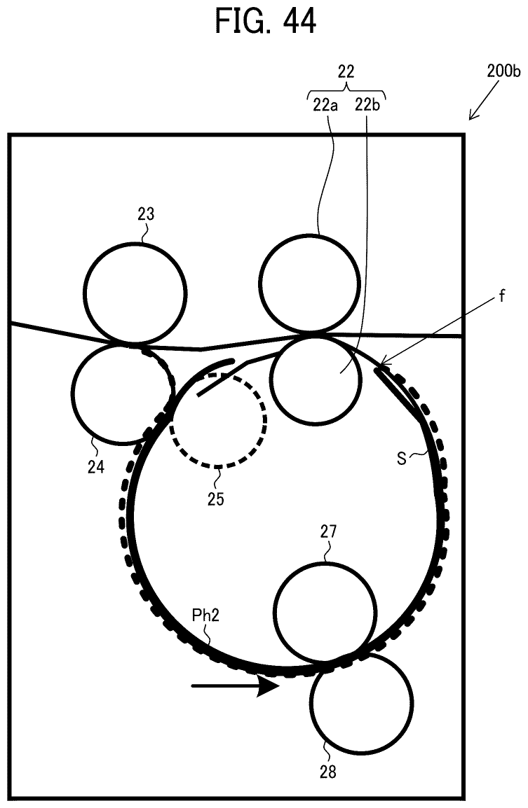

FIG. 44 is a diagram for illustrating a configuration and an operation of a folding processing unit 200b according to the present embodiment.

The folding processing unit 200b includes a conveyance roller pair for relay (a first return relay conveyance roller 27 and a second return relay conveyance roller 28) on a return conveyance passage Ph2.

The first return relay conveyance roller 27 forming a relay conveyor is a roller for conveying a sheet S having passed through a nip between a second folding roller 24 and a third folding roller 25 toward a joining position B by the nip with the second return relay conveyance roller 28, and includes a peripheral surface formed of an elastic body such as rubber. The first return relay conveyance roller 27 receives a driving force from a drive source via a gear and rotates in a forward direction or a reverse direction.

The second return relay conveyance roller 28 similarly forming the relay conveyor is a roller for conveying the sheet S having passed through the nip between the second folding roller 24 and the third folding roller 25 toward the joining position B by the nip with the first return relay conveyance roller 27, and includes a peripheral surface formed of an elastic body such as rubber. The second return relay conveyance roller 28 also receives a driving force from a drive source via a gear and rotates in a forward direction or a reverse direction.

It is possible to convey so as to absorb a sheet length difference by applying a devise similar to that for the second folding roller 24 and the third folding roller 25 according to the first embodiment to the first return relay conveyance roller 27 and the second return relay conveyance roller 28. In this case, a roller diameter is set or the number of teeth of the gear is set for the first return relay conveyance roller 27 as for the third folding roller 25. The roller diameter is set and the number of teeth of the gear is set for the second return relay conveyance roller 28 as for the second folding roller 24.

### Fourth Embodiment

As in the first to third embodiments already described, in a case where the difference in diameter between the rollers or the difference in rotation amount (reduction ratio) is used to absorb the sheet length difference occurring when the sheet S on which the proper fold fis formed is conveyed by the return conveyance passage Ph2, there might be a concern about wear between the rollers.

In other words, in a case where the second folding roller 24 and the third folding roller 25 continue rotating in a state in which the sheet S is not nipped, when the rollers having different rotation amounts always come into contact with each other and rotate, roller surfaces are in a state of being rubbed against each other, so that they wear slightly.

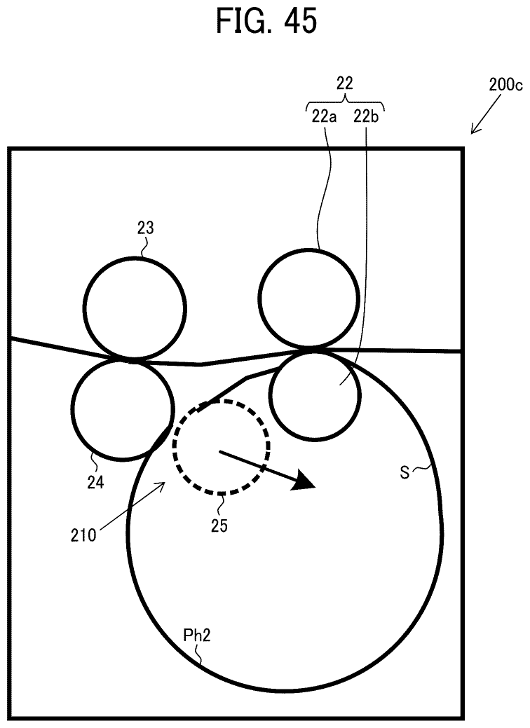

For this reason, as illustrated in FIG. 45, in consideration of durability of a folding roller, a folding processing unit 200c according to the present embodiment includes a roller contact-separation mechanism 210 obtained by combining a separation mechanism for separating the nip when the sheet S is not conveyed and a contact mechanism for allowing the nip to contact.

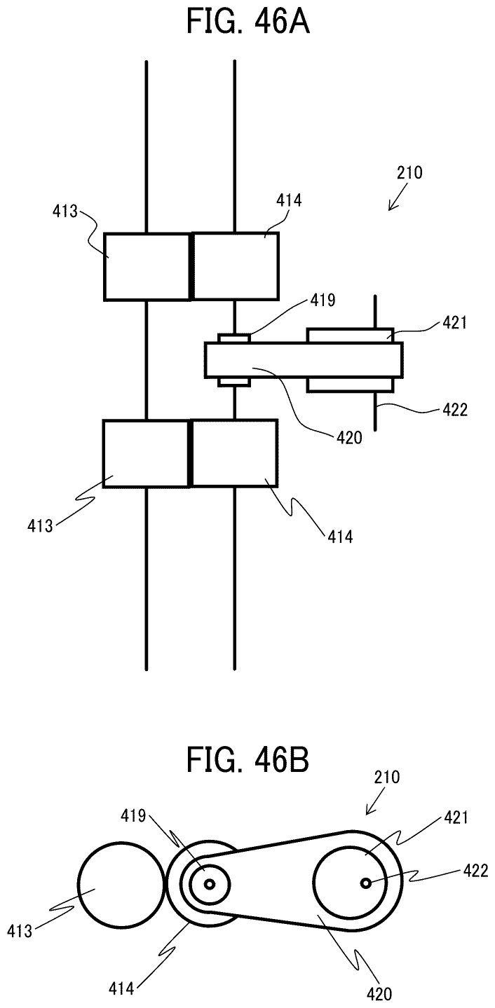

FIGS. 46A and 46B are diagrams for illustrating the roller contact-separation mechanism 210 included in the folding processing unit 200c. As illustrated in FIGS. 46A and 46B, the roller contact-separation mechanism 210 includes a third folding roller bearing 419, a link 420, an eccentric cam 421, and a camshaft 422.

The third folding roller bearing 419 is a bearing provided on a roller shaft of the third folding roller 25. This idles to slide with respect to the roller shaft of the third folding roller 25.

The link 420 is a link (coupling member) fitted to the third folding roller bearing 419 and the eccentric cam 421 so as to idle to slide.

The eccentric cam 421 rotates to drive the link 420, and eccentrically separates the third folding roller 25 from the second folding roller 24.

The camshaft 422 is a rotation shaft of the eccentric cam 421.

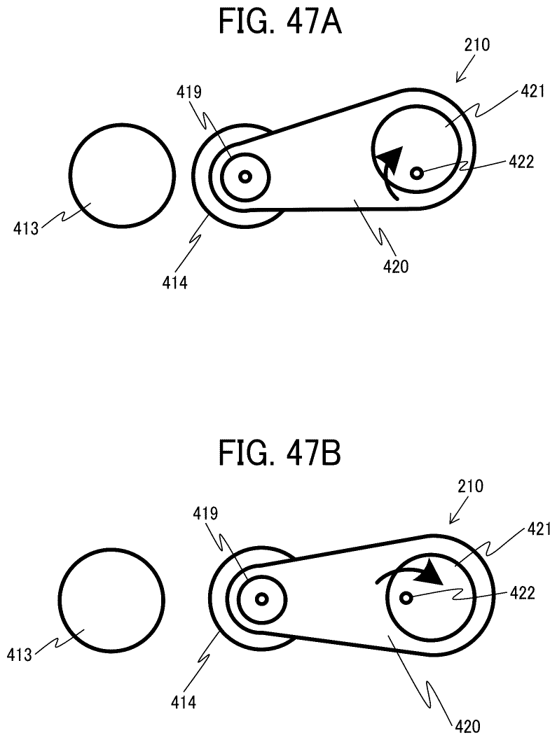

In the roller contact-separation mechanism 210, when the eccentric cam 421 is rotated about the camshaft 422 as illustrated in FIG. 47A, the eccentric cam pulls the link 420 in a rotational direction as illustrated in FIG. 47B. By the operation of the link 420, the third folding roller 25 is moved in a direction away from the second folding roller 24.

The roller contact-separation mechanism 210 may be provided in either the first return relay conveyance roller 27 or the second return relay conveyance roller 28 described in the third embodiment.

### Fifth Embodiment

A description is given of a fifth embodiment of a sheet processing apparatus according to the present disclosure.

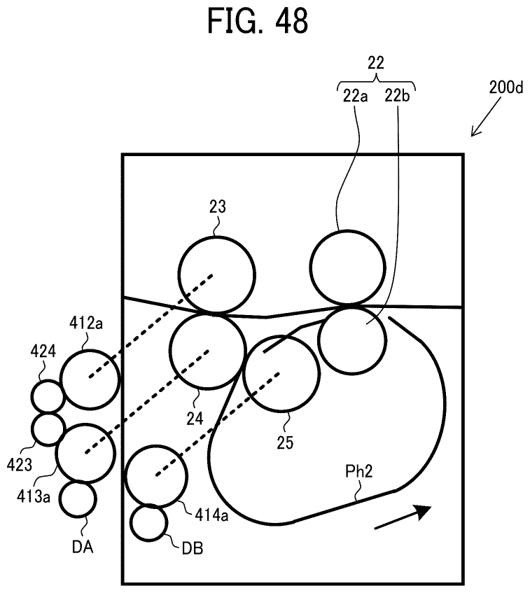

FIG. 48 is a diagram for illustrating a configuration and an operation of a folding processing unit 200d according to the present embodiment.

The folding processing unit 200d includes a driving member that drives a first folding roller 23, a second folding roller 24, and a third folding roller 25 separately. With this configuration, conveyance that can absorb a sheet length difference is implemented.

As illustrated in FIG. 48, a folding processing unit 200d includes a first folding drive gear 412a, a second folding drive gear 413a, and a third folding drive gear 414a as driving members, in addition to the already described folding processing unit 200. The first folding drive gear 412a is a drive gear that transmits a driving force of the first folding roller 23. The second folding drive gear 413a is a drive gear that transmits a driving force of the second folding roller 24. The third folding drive gear 414a is a drive gear that transmits a driving force of the third folding roller 25.

The folding processing unit 200 includes a first idler gear 423 that couples the drive gears of the first folding roller 23 and the second folding roller 24, and a second idler gear 424 that couples the drive gears of the first folding roller 23 and the second folding roller 24.

The first folding roller 23 and the second folding roller 24 are coupled by the drive gear and driven by a drive source DA. In order for the first folding roller 23 and the second folding roller 24 to convey paper, it is necessary to couple gears such that rotational directions of the first folding roller 23 and the second folding roller 24 are opposite to each other.

The third folding roller 25 is driven by the drive source DB, and the third folding roller 25 is driven separately from the first folding roller 23 and the second folding roller 24.

The rotational directions of the second folding roller 24 and the third folding roller 25 need to be opposite in order to convey the sheet S, and there are separate drive sources, so that it is sufficient to control the rotational direction by the drive source.

In the second embodiment and the third embodiment, since the second folding roller 24 and the third folding roller 25 are assumed to be driven by the same driving, when a difference in conveyance amount is made by a roller diameter or a reduction ratio, there is a concern of wear due to rubbing between the rollers when they rotate without the sheet S nipped.

In the folding processing unit 200d according to the fifth embodiment, the second folding roller 24 and the third folding roller 25 are separately driven, so that there is a difference in conveyance amount when conveying the sheet S, and the conveyance amount is made the same at times other than when conveying the sheet S, thereby eliminating the concern of wear.

Here, the second folding roller 24 is of a drive source DA, and the third folding roller 25 is of a drive source DB. When conveying the sheet S, a relationship between the rotation amount of the drive source DA and the rotation amount of the drive source DB is set such that the rotation amount of the drive source DA>the rotation amount of the drive source DB, so that the conveyance distance of the third folding roller 25 is reduced, and when a fold reaches the nip of the conveyance roller pair 22 a nip portion and a fold position are aligned.

When the sheet S is not conveyed, the number of rotations of the drive source DA=the number of rotations of the drive source DB can be set so that wear due to rubbing of the rollers does not occur. Alternatively, when the sheet S is not conveyed, a driven roller can be formed by not allowing a current to flow in the drive source DB, and this is rotated together with the drive source DA, so that wear can be prevented.

### Sixth Embodiment

A description is given of a sixth embodiment of a sheet processing apparatus according to the present disclosure.

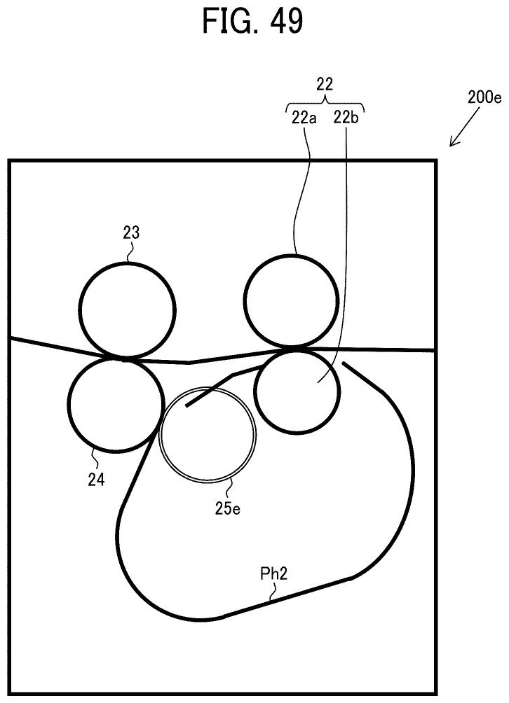

FIG. 49 is a diagram for illustrating a configuration and an operation a folding processing unit 200e according to the present embodiment.

Each folding roller described in the first to fifth embodiments is assumed to be made of the same material, but a material of a third folding roller 25e according to the present embodiment is made different from a material of a second folding roller 24 to provide a difference in slipping property. Accordingly, a sheet length difference can be absorbed.

When a surface friction coefficient of a surface material of the second folding roller 24 is set to FA and a surface friction coefficient of a surface material of the third folding roller 25e is set to FB, there is no difference in conveyance amount in a case of FA=FB, and thus box-fold occurs due to the sheet length difference of a turn passage. When FA>FB, the third folding roller 25e easily slips because it is difficult to slip with a higher surface frictional coefficient but easy to slip with a lower surface frictional coefficient. As a result, since a substantial conveyance distance is reduced, a nip position and a fold position are brought close to each other when a proper fold f reaches a nip of a conveyance roller pair 22. In this case, since there is no difference in rotation amount of the roller, there is no wear, and thus a separation mechanism and separate driving are not necessary.

In any of the first to sixth embodiments described above, when the folding process of the sheet S is performed using the return conveyance passage Ph2, the conveyance amount of the sheet S by the roller disposed on the inner peripheral side and the roller disposed on the outer peripheral side in the conveyance passage having the curvature is not set to the same amount and can be adjusted. As a result, the proper fold f formed by the folding process is set at the head of the conveyance with respect to the nip of the roller pair on the conveyance passage. Accordingly, box-fold can be prevented, and the quality of the folding process can be improved.

The present disclosure is not limited to the embodiments described above, and various variations are possible within the scope of the technical gist thereof, and all the technical matters included in the technical idea recited in claims are the object of the present disclosure. The embodiments described above illustrate a suitable example, and one skilled in the art can implement various variations from the disclosed contents. Such variations are included in the technical scope disclosed in claims.

A description is given below of some aspects of an embodiment of the present disclosure.

### Aspect 1

In Aspect 1, a sheet processing apparatus includes a conveyor, a first folding roller, a second folding roller, a return conveyance passage, and a third folding roller. The conveyor conveys a sheet along a main conveyance passage. The second folding roller is disposed facing the first folding roller across the main conveyance passage. The return conveyance passage has a curvature. The return conveyance passage is branched from the main conveyance passage at a branching position upstream from the first folding roller in a conveyance direction of the sheet and is merged to the main conveyance passage at a merging position upstream from the branching position in the conveyance direction of the sheet. The third folding roller is disposed at a position facing the second folding roller across the return conveyance passage. The second folding roller corresponds to an outer peripheral roller of the return conveyance passage and the third folding roller corresponds to an inner peripheral roller of the return conveyance passage, when the sheet is conveyed to the return conveyance passage. The third folding roller conveys the sheet by a conveyance amount that is smaller than a conveyance amount by which the second folding roller conveys the sheet.

### Aspect 2

In Aspect 2, the sheet processing apparatus according to Aspect 1 further includes a relay conveyor to convey the sheet in a direction from the branching position to the merging position in the return conveyance passage. The relay conveyor includes a relay conveyance roller pair including an inner peripheral relay roller disposed on an inner side of the return conveyance passage, and an outer peripheral relay roller disposed on an outer side of the return conveyance passage. The inner peripheral relay roller conveys convey the sheet by a conveyance amount that is smaller than a conveyance amount by which the second folding roller conveys the sheet in the return conveyance passage.

### Aspect 3

In Aspect 3, in the sheet processing apparatus according to Aspect 1 or 2, the conveyance amount by the inner peripheral roller and the conveyance amount by the outer peripheral roller are determined based on a passage gap in the return conveyance passage and a thickness dimension of the sheet.

### Aspect 4

In Aspect 4, in the sheet processing apparatus according to any one of Aspects 1 to 3, the inner peripheral roller has a diameter that is smaller than a diameter of the outer peripheral roller facing the inner peripheral roller.

### Aspect 5

In Aspect 5, in the sheet processing apparatus according to any one of Aspects 1 to 4, a number of teeth of a gear as a driver to rotate the inner peripheral roller or a diameter of the gear is larger than a number of teeth of a gear as a driver to rotate the outer peripheral roller or a diameter of the gear.

### Aspect 6

In Aspect 6, in the sheet processing apparatus according to any one of Aspects 1 to 5, a surface friction coefficient of the inner peripheral roller is lower than a surface friction coefficient of the outer peripheral roller facing the inner peripheral roller.

### Aspect 7

In Aspect 7, the sheet processing apparatus according to any one of Aspects 1 to 6 further includes a roller contact-separation mechanism to cause the inner peripheral roller and the outer peripheral roller facing the inner peripheral roller to relatively contact or separate from each other.

### Aspect 8

In Aspect 8, in the sheet processing apparatus according to any one of Aspects 1 to 7, the inner peripheral roller is driven by a first drive source and the outer peripheral roller is driven by a second drive source that is different from the first drive source. A number of rotations of the first drive source of the inner peripheral roller is lower than a number of rotations of the second drive source of the outer peripheral roller, when the sheet passes through a nip between the inner peripheral roller and the outer peripheral roller. The number of rotations of the first drive source of the inner peripheral roller and the number of rotations of the second drive source of the outer peripheral roller are same, when the sheet does not pass through the nip between the inner peripheral roller and the outer peripheral roller.

### Aspect 9

In Aspect 9, in the sheet processing apparatus according to Aspect 8, the outer peripheral roller is rotated with the inner peripheral roller, when the sheet does not pass through the nip between the inner peripheral roller and the outer peripheral roller.

### Aspect 10

In Aspect 10, an image forming apparatus includes a housing, an image forming device included in the housing to form an image on a sheet, and the sheet processing apparatus according to any one of Aspects 1 to 9 being detachably attached to the housing. The sheet processing apparatus performs a given process on the sheet on which an image is formed by the image forming device.

### Aspect 11

In Aspect 11, the image forming apparatus according to Aspect 10 further includes a post-processing device to perform a given post-process on the sheet on which an image is formed by the image forming device. The sheet processing apparatus is detachably attached to the housing at a position downstream from the image forming device and upstream side from the post-processing device in a conveyance passage of the sheet from the image forming device to the post-processing device.

### Aspect 12

In Aspect 12, in the image forming apparatus according to Aspect 11, the image forming device forms respective images on multiple sheets including the sheet, and the post-process is a binding process in which multiple sheets including the sheet are bound into a sheet bundle.

### Aspect 13

In Aspect 13, the image forming apparatus according to Aspect 12 further includes a controller switchable between a first control in which the multiple sheets having the respective images formed by the image forming device are folded in the sheet processing apparatus and delivered to the post-processing device and a second control in which the multiple sheets having the respective images formed by the image forming device are not folded in the sheet processing apparatus and delivered to the post-processing device.

### Aspect 14

In Aspect 14, an image forming system includes an image forming apparatus to form an image on a sheet, and the sheet processing apparatus according to claim 1 coupled to the image forming apparatus.

### Aspect 15

In Aspect 15, a sheet processing apparatus includes a conveyor, a first folding roller, a second folding roller, a return conveyance passage, and a third folding roller. The conveyor conveys a sheet along a main conveyance passage in a conveyance direction. The second folding roller is disposed facing the first folding roller across the main conveyance passage and conveys the sheet by a first conveyance amount. The return conveyance passage has a curvature. The return conveyance passage is branched from the main conveyance passage at a branching position upstream from the first folding roller in the conveyance direction, and merged to the main conveyance passage at a merging position upstream from the branching position in the conveyance direction. The third folding roller is disposed facing the second folding roller across the return conveyance passage and conveys the sheet by a second conveyance amount smaller than the first conveyance amount of the second folding roller. The second folding roller is disposed on an outer peripheral side of the return conveyance passage, and the third folding roller is disposed on an inner peripheral side of the return conveyance passage.

### Aspect 16

In Aspect 16, the sheet processing apparatus according to Aspect 15 further includes a relay conveyor in the return conveyance passage to convey the sheet in a return direction from the branching position to the merging position. The relay conveyor includes a relay conveyance roller pair including an inner peripheral relay roller and an outer peripheral relay roller. The inner peripheral relay roller is disposed on the inner peripheral side of the return conveyance passage and conveys the sheet by a third conveyance amount. The outer peripheral relay roller is disposed on the outer peripheral side of the return conveyance passage and conveys the sheet by a fourth conveyance amount larger than the third conveyance amount of the inner peripheral relay roller.

### Aspect 17

In Aspect 17, in the sheet processing apparatus according to Aspect 15 or 16, the third conveyance amount of the inner peripheral roller and the fourth conveyance amount of the outer peripheral roller are determined based on a passage gap in the return conveyance passage and a thickness dimension of the sheet.

### Aspect 18

In Aspect 18, in the sheet processing apparatus according to any one of Aspects 15 to 17, the outer peripheral roller faces the inner peripheral roller, and the inner peripheral roller has a diameter smaller than a diameter of the outer peripheral roller.

### Aspect 19

In Aspect 19, the sheet processing apparatus according to any one of Aspects 15 to 18 further includes a first driver and a second driver. The first driver includes a first gear having first teeth having a first teeth number and a first diameter to rotate the inner peripheral roller. The second driver includes a second gear having second teeth having a second teeth number and a second diameter to rotate the outer peripheral roller. The first teeth number is larger than the second teeth number, or the first diameter is larger than the second diameter.

### Aspect 20

In Aspect 20, in the sheet processing apparatus according to any one of Aspects 15 to 19, the outer peripheral roller faces the inner peripheral roller, and the inner peripheral roller has a surface friction coefficient lower than a surface friction coefficient of the outer peripheral roller.

### Aspect 21

In Aspect 21, the sheet processing apparatus according to any one of Aspects 15 to 20 further includes a roller contact-separation mechanism to cause the inner peripheral roller and the outer peripheral roller facing the inner peripheral roller to relatively contact with each other or separate from each other.

### Aspect 22

In Aspect 22, the sheet processing apparatus according to any one of Aspects 15 to 21 further includes a first drive source and a second drive source. The first drive source drives the inner peripheral roller. The second drive source is different from the first drive source and drives the outer peripheral roller. The first drive source drives the inner peripheral roller with a first number of rotations. The second drive source drives the outer peripheral roller with a second number of rotations larger than the first number of rotations while the sheet passes through a nip between the inner peripheral roller and the outer peripheral roller. The second drive source drives the outer peripheral roller with a second number of rotations equal to the first number of rotations while the sheet does not pass through the nip between the inner peripheral roller and the outer peripheral roller.

### Aspect 23

In Aspect 23, in the sheet processing apparatus according to Aspect 22, the outer peripheral roller is rotated with the inner peripheral roller, when the sheet does not pass through the nip between the inner peripheral roller and the outer peripheral roller.

### Aspect 24

In Aspect 24, an image forming apparatus includes a housing, an image forming device included in the housing to form an image on a sheet, and the sheet processing apparatus according to any one of Aspects 14 to 23 being detachably attached to the housing. The sheet processing apparatus performs a given process on the sheet on which an image is formed by the image forming device.

### Aspect 25

In Aspect 25, the image forming apparatus according to Aspect 24 further includes a post-processing device to perform a given post-process on the sheet on which an image is formed by the image forming device. The sheet processing apparatus is detachably attached to the housing at a position downstream from the image forming device and upstream side from the post-processing device in a conveyance passage of the sheet from the image forming device to the post-processing device.

### Aspect 26

In Aspect 26, in the image forming apparatus according to Aspect 25, the image forming device forms respective images on multiple sheets including the sheet, and the post-process is a binding process in which multiple sheets including the sheet are bound into a sheet bundle.

### Aspect 27

In Aspect 27, the image forming apparatus according to Aspect 26 further includes a controller switchable between a first control in which the multiple sheets having the respective images formed by the image forming device are folded in the sheet processing apparatus and delivered to the post-processing device and a second control in which the multiple sheets having the respective images formed by the image forming device are not folded in the sheet processing apparatus and delivered to the post-processing device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. A sheet processing apparatus comprising:
a conveyor to convey a sheet along a main conveyance passage in a conveyance direction;
a first folding roller;
a second folding roller, facing the first folding roller across the main conveyance passage, to convey the sheet by a first conveyance amount;
a return conveyance passage having a curvature, the return conveyance passage being:
branched from the main conveyance passage at a branching position upstream from the first folding roller in the conveyance direction; and
merged to the main conveyance passage at a merging position upstream from the branching position in the conveyance direction; and
a third folding roller, facing the second folding roller across the return conveyance passage, to convey the sheet by a second conveyance amount smaller than the first conveyance amount of the second folding roller,
wherein the second folding roller disposed on an outer peripheral side of the return conveyance passage, and
the third folding roller disposed on an inner peripheral side of the return conveyance passage.

2. The sheet processing apparatus according to claim 1, further comprising a relay conveyor in the return conveyance passage to convey the sheet in a return direction from the branching position to the merging position,
wherein the relay conveyor includes a relay conveyance roller pair including:
an inner peripheral relay roller, disposed on the inner peripheral side of the return conveyance passage, to convey the sheet by a third conveyance amount; and
an outer peripheral relay roller, disposed on the outer peripheral side of the return conveyance passage, to convey the sheet by a fourth conveyance amount larger than the third conveyance amount of the inner peripheral relay roller.

3. The sheet processing apparatus according to claim 1,
wherein the third conveyance amount of the inner peripheral roller and the fourth conveyance amount of the outer peripheral roller are determined based on a passage gap in the return conveyance passage and a thickness dimension of the sheet.

4. The sheet processing apparatus according to claim 1,
wherein the outer peripheral roller faces the inner peripheral roller, and
the inner peripheral roller has a diameter smaller than a diameter of the outer peripheral roller.

5. The sheet processing apparatus according to claim 1, further comprising:
a first driver including a first gear having first teeth having a first teeth number and a first diameter to rotate the inner peripheral roller; and
a second driver including a second gear having second teeth having a second teeth number and a second diameter to rotate the outer peripheral roller,
wherein the first teeth number is larger than the second teeth number, or the first diameter is larger than the second diameter.

6. The sheet processing apparatus according to claim 1,
wherein the outer peripheral roller faces the inner peripheral roller, and
the inner peripheral roller has a surface friction coefficient lower than a surface friction coefficient of the outer peripheral roller.

7. The sheet processing apparatus according to claim 1, further comprising:
a roller contact-separation mechanism to cause the inner peripheral roller and the outer peripheral roller facing the inner peripheral roller to relatively contact with each other or separate from each other.

8. The sheet processing apparatus according to claim 1, further comprising:
a first drive source to drive the inner peripheral roller; and
a second drive source different from the first drive source, to drive the outer peripheral roller,
wherein the first drive source drives the inner peripheral roller with a first number of rotations,
the second drive source drives the outer peripheral roller with a second number of rotations larger than the first number of rotations while the sheet passes through a nip between the inner peripheral roller and the outer peripheral roller, and
the second drive source drives the outer peripheral roller with a second number of rotations equal to the first number of rotations while the sheet does not pass through the nip between the inner peripheral roller and the outer peripheral roller.

9. The sheet processing apparatus according to claim 8,
wherein the outer peripheral roller is rotated with the inner peripheral roller, when the sheet does not pass through the nip between the inner peripheral roller and the outer peripheral roller.

10. An image forming apparatus comprising:
a housing;
an image forming device included in the housing to form an image on a sheet; and
the sheet processing apparatus according to claim 1 being detachably attached to the housing, the sheet processing apparatus to perform a given process on the sheet on which an image is formed by the image forming device.

11. The image forming apparatus according to claim 10, further comprising:
a post-processing device to perform a given post-process on the sheet on which an image is formed by the image forming device,
wherein the sheet processing apparatus is detachably attached to the housing at a position downstream from the image forming device and upstream side from the post-processing device in a conveyance passage of the sheet from the image forming device to the post-processing device.

12. The image forming apparatus according to claim 11,
wherein the image forming device forms respective images on multiple sheets including the sheet, and
the post-process is a binding process in which multiple sheets including the sheet are bound into a sheet bundle.

13. The image forming apparatus according to claim 12, further comprising a controller switchable between:
a first control in which the multiple sheets having the respective images formed by the image forming device are folded in the sheet processing apparatus and delivered to the post-processing device, and
a second control in which the multiple sheets having the respective images formed by the image forming device are not folded in the sheet processing apparatus and delivered to the post-processing device.
